(19) United States
(12) Patent Application Publication
(10) Pub. No.: US 2015/0014891 A1
(43) Pub. Date: Jan. 15, 2015

(54) PATTERNED THIN FILMS BY THERMALLY INDUCED MASS DISPLACEMENT

(71) Applicants: Glenn G. Amatucci, Peapack, NJ (US); Anthony Ferrer, North Brunswick, NJ (US)

(72) Inventors: Glenn G. Amatucci, Peapack, NJ (US); Anthony Ferrer, North Brunswick, NJ (US)

(21) Appl. No.: 14/202,972

(22) Filed: Mar. 10, 2014

Related U.S. Application Data
(60) Provisional application No. 61/775,082, filed on Mar. 8, 2013.

(51) Int. Cl. B23K 26/00; B23K 26/08

(52) U.S. Cl. CPC B23K 26/0084; B23K 26/0081; B23K 26/08; B23K 26/0051
USPC 264/447; 219/121.66

(57) ABSTRACT

The described invention provides a method of patterning a thin film deposited on a substrate comprising applying a moving focused field of thermal energy to the thin film deposited on the substrate; and dewetting the thin film from the substrate. Dewetting the thin film from the substrate is characterized by a negative space of a desired design; and displacement of the thin film into adjacent structures, thereby accumulating thin film in the adjacent structures.

### CROSS-REFERENCE TO RELATED APPLICATIONS

This application claims the benefit of priority to U.S. Provisional Application 61/775,082 (filed Mar. 8, 2013), the contents of which are incorporated by reference in its entirety.

### STATEMENT OF GOVERNMENT FUNDING

This invention was made with government support. The government has certain rights in the invention.

### FIELD OF THE INVENTION

The described invention addresses a new way of patterning thin films which overcomes the shortcomings of approaches used today. More specifically, the described invention utilizes a technique to apply a relatively low powered focused beam to dewet a metal from a substrate and effectively write the negative space of the desired design without significant loss of deposited film mass and little damage to heat sensitive substrates. Additionally, this process allows one to displace material into adjacent structures, thereby building film thickness, without the requirement of depositing thicker films.

### BACKGROUND OF THE INVENTION

Thin film patterning is an essential technology that has enabled the miniaturization of many technologies in both the electronics and biomedical fields. Patterned thin films can be found in a variety of electronics applications including batteries, solar cells, transistors, microfluidics, patch antennas, and touch panels [Yagi, I., et al., “Direct observation of contact and channel resistance in pentacene four-terminal thin-film transistor patterned by laser ablation method,” Appl. Phys. Lett. 84 (2004) 813-815; Cho, G., et al., “Patterned Si thin film electrodes for enhancing structural stability,” Nanoscale Research Letters 7:20 (2012) 1-5; Tseng, S-F., et al., “Laser scribing of indium tin oxide (ITO) thin films deposited on various substrates for touch panels” (2010); Gecys, P., et al., “Scribing of Thin-film Solar Cells with Picosecond Laser Pulses” (2011); Ruthe, D., et al., “Etching of CuInSe2 thin films—comparison of femtosecond and picosecond laser ablation” (2005)]. The biomedical field has developed a great need for such thin electrode arrays as well, particularly for point-of-care applications. Concepts such as the “lab-on-chip,” implantable sensors, and ingestible probes rely on the biotech industry's ability to accurately and reproducibly create microscopic electrical conduits on increasingly thin substrates [Henderson, R. D., et al., “Lab-on-a-Chip device with laser-patterned polymer electrodes for high voltage application and contactless conductivity detection” Chem. Commun., 48 (2012) 9287-9289; Chin, C. D., et al., “Commercialization of microfluidic point-of-care diagnostics devices,” Lab Chip 12 (2012) 2118-2134]. Additionally, the use of organic, flexible substrates will allow implementation of such electrodes into a wider range of products for both industries that can provide users and researchers with highly adaptable geometries for consumer and industrial electronics. If devices are to progressively occupy less space and continually exhibit higher functionality, all while remaining relatively low cost, then industrial processes must match this demand by developing innovative ways of patterning deposited thin films.

Two of the most prevalent modes of patterning thin films are shadow masked deposition and photolithography [Glang, Reinhard, and Lawrence V. Gregor. “Generation of Patterns in Thin Films.” Handbook of Thin Film Technology, New York: McGraw-Hill, (1970) 7.1-7.66]. The former technique requires the creation of multiple yet expensive masks, which make changing designs, even slightly, both costly and time-consuming. The latter technique also uses masks for the purposes of patterning the area of exposure and incorporates various photoresists and chemical development steps leading to highly accurate features. In turn, the process is complicated and introduces the need for a number of extra environmental engineering controls to deal with such potentially harmful chemicals. Some of drawbacks can be mitigated by using directed energy techniques to scribe out the negative space of a film, precluding the need for masks or etching steps. Such processes can use focused e-beams or laser radiation coupled with a scanning system to reduce production time, however, these techniques are still primarily subtractive in nature and result in the vaporization of a great deal of material that cannot be recovered. Other techniques, including those that are additive in nature (e.g. ink jet printing) [Levy, D. H., et al., “Metal-oxide thin-film transistors patterned by printing,” Appl. Phys. Lett. 103 (2013) 043505], have their own drawbacks that must be overcome during implementation into current manufacturing processes. An alternative to current patterning techniques involves the use of dewetting to build patterned structures from an initially uniform target layer.

The shape of liquids on solid surfaces is dictated by the contact angle (FIG. 10). The latter is related to the materials' surface energy by the Young's Equation (Equation 1), where θ_{c} is the contact angle in thermodynamic equilibrium. Liquids that completely wet the solid correspond to θ_{c}=0°. Angles between 0° and 90° can be considered partially wetting, while angles greater than 90° are formed by non-wetting liquids. The wetting nature of a material can be described by the change in free energy with respect to the standard state, i.e. complete wetting of the solid by the liquid [Gentili, D., et al., “Applications of dewetting in micro and nanotechnology,” Chem. Soc. Rev. 41 (2012)4430-4443]. This free energy is a combination of gravitational forces, intermolecular forces, and surface tension (Equation 2). Surface topography will affect the apparent contact angle and by consequence the measured surface energy; however, materials will exhibit surface energy values in general domains intrinsic to material classification. For example, metals tend to lie in the highest range of surface energy values, while materials such as polymers tend to have the lowest values. Interfacial force influences the dewetting of metallic films deposited on substrates such as glass or polymeric compounds and can be measured by the spreading coefficient S (Equation 3). A film will spontaneously dewet when the change in free energy S<0 and has a thickness less than a critical height. In turn, this critical height is a function of capillary length and equilibrium contact angle and provides the basis for determining energetic stability of the film with respect to the substrate [Sharma, A. and Ruckenstein, E. “Energetic Criteria for the Breakup of Liquid Films on Nonwetting Solid Surfaces,” Journal of Colloid and Interface Science. 137, 2(1990) 433-445]. Studies on polymer films have shown that dewetting can occur by a number of mechanisms, including nucleation and growth of holes within the film and spontaneous spinodal dewetting [Stange, T. G., Evans, D. F., “Nucleation and Growth of Defects Leading to Dewetting of Thin Polymer Films” Langmuir 13 (1997) 4459-4465; Xie, R., et al., “Spinodal Dewetting of Thin Polymer Films,” Phys. Rev. Lett. 81, 6 (1998) 1251-1254]. Researchers have also initiated dewetting in films that would not do so independently. A number of mechanical methods have been employed, rather than relying on random impurities to serve as nucleation points [Pandit, A. B., and Davidson, J. F. “Hydrodynamics of the rupture of thin liquid films” J. Fluid Mech. 212, 11 (1990) 11-24; Redon, C., et al., “Dynamics of Dewetting” Phys. Rev. Lett. 66, 6 (1991) 715-718]. By introducing this external energetic input, some control is established over the dewetting geometry and progression of a film on non-wetting surfaces.

$$\begin{matrix}{γ}_{SL} + {γ}_{LG} cos {θ}_{c} = {γ}_{SG} & ( 1 ) \\ Δ F ( h ) = \frac{1}{2} ρ {gh}^{2} - S + \frac{A}{12 π {h}^{2}} & ( 2 ) \\ S = {γ}_{SG} - ( {γ}_{SL} + {γ}_{LG} ) & ( 3 )\end{matrix}$$

The described invention presents a novel variation on induced dewetting which allows for rapid, directed patterning through the use of a high speed scanning laser. For example, by taking a relatively low-powered Yb doped fiber laser and scanning it across the surface of a metallic thin-film, targeted melting and dewetting of the target film can be achieved without damaging the underlying polymer substrate. There is some precedent for induced dewetting of metallic, thin film targets under a variety of non-scanning laser radiation conditions. In 1996, Bischof et. al. studied the dewetting modes of thin films after exposure from frequency doubled Nd:YAG radiation [Bischof, J., et al., “Dewetting Modes of Thin Metallic Films: Nucleation of Holes and Spinodal Dewetting,” Physical Review Letters (1996) 77 (8) 1536-1539]. The authors demonstrate that deposited Au, Cu, and Ni thin films, which are metastable in nature, will dewet upon induced melting and will do so by nucleation of holes or by a spontaneous, spinodal fashion. Other researchers have built upon this dewetting phenomenon to create self-assembled features on Co nano-films by using defocused laser light and pulses in the nanosecond regime [Favazza, C., et al., “Robust nanopatterning by laser-induced dewetting of metal nanofilms,” Nanotechnology 17 (2006) 4229-4234]. It was shown that characteristic length scales developed as functions of the number pulses used, which allowed some control over the final dimensions of the pattern. Splitting a laser source into two or three beams to create interference has enabled the creation of periodic patterns on a variety of thin-film species, including Bi, Ge, Ni, Au, Cu, and. Ta. Changing the arrangement and number of beams allows even more control over pattern design; however, such techniques are very much limited to lines, hexagonal patterns, and others associated with intensity interference [Riedel, S., et al., “Nanostructuring of thin films by ns pulsed laser interference,” Appl Phys A 101, (2010) 309-312; Riedel, S., et al., “Pulsed Laser Interference Patterning of Metallic Thin Films” Acta Physica Polonica A 121, 2 (2012) 385-387]. Placing masks along the beam path, which are then focused down to a smaller scale, offered additional freedom in shape patterning similar to photoresist methods, but suffer from the same drawbacks [Kuznetsov, A. I., et al., “Nanostructuring of thin gold films by femtosecond lasers,” Appl Phys A 94, (2009) 221-230]. Pre-patterning of the thin film, followed by laser exposure imposes constraints on the acting surface tension in the melt and allowed a “directed assembly” of the dewetted material [Rack, P. D., et al., “Pulsed laser dewetting of patterned thin metal films: A means of directed assembly” Applied Physics Letters 92, 223108 (2008); Fowlkes, J. D., et al., “Self-Assembly versus Directed Assembly of nanoparticles via Pulsed Laser Induced Dewetting of Patterned Metal Films” Nano Letters 11 (2011), 2478-2485]. The techniques still require the creation of masks for electron lithography and the subsequent use of lift-off processes, which hinders the speed of implementation. In sharp contrast to the aforementioned techniques, the processing technique of the described invention relies on a number of system features, namely a high speed scanning system that affords the user a great deal of freedom in rapid direct scribe dewetting programs, while eliminating the need for costly lithographic masks and time-consuming pre-patterning steps.

Choice of system materials is crucial to the technique of the described invention as a number of attributes can affect both the dewetting behavior of the metal as well as its interaction with the laser radiation (Table 1). For example, bismuth as the deposited metal has a relatively low melting-point with a much higher vaporization-point, and a large liquid surface tension value. Additionally, bismuth absorbs a relatively large percentage of incident near-infrared (NIR) radiation, whereas other metals may reflect a much larger percentage of incident radiation at that wavelength. The combination of low melting temperature and higher absorption makes it particularly applicable to polymer substrates. Tin presents as another viable candidate, as it also has a low melting point, high vaporization point, high surface tension, and exhibits relatively high absorption of NIR light. However, lasers of shorter wavelengths can be utilized to enable a wide array of metals due to improved absorption characteristics. One specific phase of a material may preferentially couple with one laser wavelength over another and thus affect the ability to melt and dewet from a substrate without significant amounts of material loss. (PVD) of the target metal on the substrate, for example, enables extremely fast cooling rates and the kinetic stabilization of metal films and a metastable, uniform wetting of the substrate.

A suitable substrate would exhibit a lower surface energy than a metal, would be an insulator, and would also have reduced absorption of NIR light to avoid destruction during laser processing. Reduced absorption also allows “back-side” dewetting by transmission through the substrate. For example, both borosilicate glass and parylene-C (par-C) meet these criteria. Where glass is highly transparent to NIR light, the surface energy is relatively high compared to most polymers. Par-C boasts a surface energy comparable to polytetrafluoroethylene (PTFE) polymers, making it relatively easy for deposited metal to dewet from the surface. The polymer can be deposited upon a borosilicate glass slide, which provides the necessary rigidity during processing, but still allows subsequent removal from the substrate. By no means limiting, other substrates can also be utilized, in addition other substrates that have properties that initially seem unsuitable, such as other metals, can be enabled by a thin coating of the of the suitable substrate such as parylene on the surface. Physical vapor deposition

TABLE 1
Relevant properties of target and substrate candidates

| | | | | Surface Energy | | |
|---|---|---|---|---|---|---|
| | Solid Density | Liquid Density | | [mJ/m²] | | Absorption at |
| Material | [g/cm³] | [g/cm³] | M.P. [° C.] | Solid | Liquid | 1000 nm [%] |
| Parylene-C | 1.289 | — | 290 | 19.6 | — | <15 |
| Parylene-N | 1.11 | — | 420 | 45 | — | <10 |
| Borosilicate Glass | 2.23 | — | 821 (soften) | 253.0 | — | <3 |
| Polyimide (Kapton) | 1.42 | — | 400 (soften) | 53 | — | <10 |
| PTFE (Teflon) | 2.2 | — | 327 | 20 | — | <10 |
| PVDF homopolymer | 1.78 | — | 177 | 30.3 | — | — |
| (Kynar) | | | | | | |
| Bismuth | 9.78 | 10.05 | 271.5 | 382 | 378 | — |
| Tin | 7.365 | 6.99 | 231.93 | 514 | 554 | 46 |
| Zinc | 7.14 | 6.57 | 419.55 | — | 811 | 20 |
| Gallium | 5.91 | 6.095 | 29.85 | — | 707 | — |
| Antimony | 6.697 | 6.53 | 630.63 | — | 384 | 45 |
| Aluminum | 2.7 | 2.375 | 660.32 | 41.2 | 914 | 29 |
| Indium | 7.31 | 7.02 | 1499.85 | — | 559 | — |
| Silver | 10.49 | 9.32 | 962 | 1302 | 930 | <5 |

The described invention provides a new method of patterning metallic thin films that overcomes the deficiencies of the current methods. Through the use of a focused laser deflected by a high-speed, galvanometer scanning system, a variety of fine metal patterns can be realized on a number of inorganic and organic substrates. This method exploits the metastable wetting characteristics of metallic thin films as deposited by physical vapor deposition or other techniques upon non-metallic substrates. Differences in surface energy and intermolecular forces between the target and the substrate provide a driving force for retraction of the thin film, while the thermal energy from the laser provides the energy needed to overcome the kinetic barrier. Electronically isolated feature sizes in the range of the tens of microns can be fabricated. During formation, material is displaced rather than ablated allowing controlled accumulation of the target material. This results in a user-determined increase of the metal feature thickness. The described invention provides for the creation of accurate and reproducible periodic structures, as well as complex designs. This technique provides an alternative to current thin film patterning techniques and introduces anew way of building out-of-plane structures in thickness from metallic thin films. This process easily lends itself to integration into existing industrial processes.

### SUMMARY OF THE INVENTION

According to one aspect, the described invention provides a method of patterning a thin film deposited on a substrate comprising: (A) applying a moving focused field of thermal energy to the thin film deposited on the substrate; and (B) dewetting the thin film from the substrate, the dewetting being characterized by: (i) a negative space of a desired design; and (ii) displacement of the thin film into adjacent structures, thereby accumulating thin film in the adjacent structures.

According to one embodiment, the focused field of thermal energy is from a laser. According to another embodiment, the focused field of thermal energy is at a wavelength matched to the wavelength absorbed by the thin film. According to another embodiment, the wavelength is not absorbed by the substrate.

According to one embodiment, the thin film is an inorganic compound. According to another embodiment, the thin film is comprised of a metal or metal alloy. According to another embodiment, the metal is comprised of bismuth. According to another embodiment, the metal is comprised tin.

According to one embodiment, the substrate is an inorganic substance. According to another embodiment, the inorganic substance is selected from the group consisting of glass, ceramic, silicon oxide and silicon nitride. According to another embodiment, substance is glass. According to another embodiment, the glass is borosilicate glass.

According to one embodiment, the substrate is a polymer. According to another embodiment, the polymer is parylene. According to another embodiment, the parylene is parylene C.

According to one embodiment, the substrate is a polymer coated on an inorganic substance. According to another embodiment, the polymer is parylene. According to another embodiment the parylene is parylene C. According to another embodiment, the inorganic substance is selected from the group consisting of glass, ceramic and metal. According to another embodiment, the inorganic substance is glass. According to another embodiment, the glass is borosilicate glass.

According to one embodiment, the dewetting is further characterized by minimal ablation of the thin film. According to another embodiment, the minimal ablation of the thin film is less than 10%. According to another embodiment, the minimal ablation of the thin film is less than 5%. According to another embodiment, the minimal ablation of the thin film is less than 3%. According to another embodiment, the minimal ablation of the thin film is 2.8%. According to another embodiment, the minimal ablation of the thin film is 0.5%.

According to one embodiment, a patterned film on a substrate is obtained by the method according to claim 1. According to another embodiment, the patterned film is used for the fabrication of flexible and non flexible electronics, neural arrays, sensors, electrochromics, electrochemical actuators, artificial muscles, batteries, capacitors, displays, electrochemical actuators, mechanical energy harvesters, micro fluidic devices, artificial eyes, and antennae.

### BRIEF DESCRIPTION OF THE DRAWINGS

For a more complete understanding of the present disclosure, reference is made to the following detailed description of exemplary embodiments considered in conjunction with the accompanying drawings.

FIG. 1 shows two examples of dewetting lines. A) 100 μm apart B) 125 μm apart C) Profile of 100 μm apart D) Profile of 125 μm apart

FIG. 2 shows an array of dewetted lines created with A) 55 μm spacing with corresponding B) 2D and C) 3D height maps

FIG. 3 shows aspiral laser scan to create A) “cone” structure B) profile of cone structure.

FIG. 4 shows A) 3D scan of cone structure; B) Height measurements of this cone structure indicating 80 um build up from 1.4 um of base material; and C) Volumetric analysis of cone after correcting for tilt and possible curvature of the surface. Out of 9.5×10⁶ um³ of displaced volume, only 2.6×10⁵ um³ of negative volume is unaccounted for.

FIG. 5 shows profilometer scans with corresponding pictures. A) & D) show 75 μm spacing, B) & E) show 65 μm spacing, and C) & F) show 55 μm spacing.

FIG. 6 shows a built up ridge of dewetted material (A) with corresponding profilometer data (B).

FIG. 7 shows a cross-hatch pattern created from a 2.5 μm thick base material.

FIG. 8 is an illustration of line structures formed both front-side directed dewett (A) and directed dewett (B).

FIG. 9 shows a small array of dewetted lines on top of A) borosilicate glass substrate and B) parylene polymer substrate.

FIG. 10 shows a diagram of a liquid droplet on a surface.

FIG. 11 shows that transparency of the substrates to NIR laser light allows for front-side (a) and back-side (b) dewetting of the target metal material as demonstrated in FIG. 8.

FIG. 12 shows a side view comparison of A) as-deposited, 4000 nm thick bismuth (Bi) dot and B) dewetted bismuth (Bi) dot on a parylene-C coated borosilicate glass slide.

FIG. 13 shows profilometry scans of dewetted dots under focused laser radiation. Substrates consisted of borosilicate glass microscope slides (A-C) and parylene-C deposited on glass (D-F).

FIG. 14 shows optical microscope images of bismuth (A) and tin (B) line arrays set at different line pitches. The rectangle highlights the path of a single laser pass within each presented pitch setting.

FIG. 15 shows a line array dewetted from 1.6 μm thick bismuth under focused conditions. Lines are set at a pitch of 75 μm, measured center to center. Features measured an average 3.85 μm in thickness. Characterization was conducted using (A) profilometry, (B) optical microscopy, and (C) field emission scanning electron microscopy (FESEM). Platelet structures are silver (Ag) from the conductive epoxy used for FESEM preparation. Dewetted bismuth (Bi) is demarked by arrows.

FIG. 16 shows a line array dewetted from 1.6 μm thick bismuth under focused conditions. Lines are set at a pitch of 55 μm apart, center to center, with an average height of 6.67 μm. Characterization was conducted using (A) profilometry, (B) optical microscopy, and (C) field emission scanning electron microscopy (FESEM). Dewetted Bi is demarked by the white arrows.

FIG. 17 shows electron microscope cross-sections of dewetted edges of a line array created with a 100 μm spacing distance. Dotted lines highlight the raised, dewetted beads and the connecting film in between. Platelet structures are silver (Ag) from the conductive epoxy used in sample preparation.

FIG. 18 shows defocused exposure re-processing of the 100 μm pitch features of FIG. 17. Line arrays result in a uniform height profile. Dotted lines mark where dewetted beads previously existed as shown in FIG. 17.

FIG. 19 shows optical (A) and field emission scanning electron microscopy (FESEM) (B) images of a self-contained line array measuring 2 mm×2 mm. Profilometer scans (C) were used to create a 3D height map of a dewetted line array. Volumetric analysis (D) performed on the data reveals a 0.5% discrepancy between the displaced positive and negative volumes, suggesting minimal material loss.

FIG. 20 shows profilometry of a built structure using successive laser passes.

FIG. 21 shows a spiral dewetting pattern of tin thin film.

FIG. 22 shows profilometry data on a built mound of dewetted material. Successive passes constituted a spiral path. Scan data allowed for 2D (A) and 3D (B) height measurement. Volumetric analysis (C) reveals a 2.8% discrepancy between positive and negative displaced material.

FIG. 23 shows periodic triangular structures dewetted from bismuth deposited onto a parylene-C covered glass slide. Triangular structures measured 70 μm×70 μm×100 μm. Each pass of the beam left a spacing of 30 μm of exposed parylene-C.

FIG. 24 shows a top-down view of polygonal and circular built structures (A). Tilted field emission scanning electron microscopy (FESEM) scans illustrate the height contrast between the deposited target film and the constructed features (B).

FIG. 25 shows an example of a possible inter-digit electrode system. Only one pass of the beam was necessary between each pair of electrode digits.

FIG. 26 shows the complex shapes “R” (upper left and bottom panels) and “U” (upper right and bottom panels) are formed out of the target material. Electron microscope cross-sections of the “R” shape in the upper left panel are shown in the middle panel (A, B and C of the upper left panel correspond to A, B and C of the middle panel).

### DETAILED DESCRIPTION OF THE INVENTION

The described invention can be better understood from the following description of exemplary embodiments, taken in conjunction with the accompanying figures and drawings. It should be apparent to those skilled in the art that the described embodiments of the described invention provided herein are merely exemplary and illustrative and not limiting.

### DEFINITIONS

Various terms used throughout this specification shall have the definitions set out herein.

The terms “ablate,” “ablated” and “ablation” as used herein, refer to the loss, removal or destruction of a material, especially by cutting, abrading or evaporating.

The term “absorb” and all variations thereof, means to take (e.g., a liquid) or draw (e.g., light, energy, etc.) in; to transform (e.g., radiant energy) into a different form especially with a resulting rise in temperature.

The term “accumulate,” and all variations thereof, means to gather, acquire or increase in amount.

The term “back-side exposure” as used herein refers to thermal energy (e.g., laser light) that is directed through substrate before interacting with a material (e.g., a metallic layer).

The terms “deposit,” “deposited,” and “deposition” as used herein, refer to the act of placing, putting or leaving an amount of substance or material on a surface or area; the amount of substance or material placed on a surface or area.

The terms “dewet,” “dewetting,” “dewetted” and all variations thereof, refer to rupture or displacement of a thin film on a liquid or solid substrate.

The term “flexible” as used herein, refers to the capability of being flexed, turned, bowed, twisted or bent without breaking.

The term “front-side exposure” as used herein, refers to the interaction of thermal energy (e.g., laser light) with a material (e.g., a metallic layer) before or without the thermal energy (e.g., laser light) being directed through a substrate.

The term “pitch” as used herein, refers to the distance between any of various things (e.g., spacing between individual lines in an array).

The term “profilometer” as used herein, refers to an instrument used to measure a surface in order to quantify its thickness and roughness. A profilometer is capable of measuring the surface of a variety of objects, including but not limited to, solids, liquids, interiors of bores and tubes, cylinders, spherical shapes, hot surfaces, cold surfaces and radioactive surfaces. A profilometer can acquire high-aspect-ratio surface features such as channels, grooves, steps, sharp edges, and the like.

The terms “push,” “pushing,” and all variations thereof, refer to the movement of existing material across the surface of a substrate to build height of features that would otherwise require an amount of additional material deposition.

The term “substrate” as used herein, refers to a solid substance or medium to which a material is applied or deposited. Non-limiting examples of substrates include borosilicate glass microscope slides and parylene-C deposited on glass.

The term “surface tension” as used herein, refers to the contractive tendency of the surface of a liquid that allows it to resist an external force. Surface tension is measured as the energy required to increase the surface area of a liquid by a unit area.

The term “thermal energy” as used herein, refers to the form of energy that is created by heat or by an increase in temperature. An example of a thermal energy source, includes but is not limited to, a laser.

The term “parylene” as used herein, refers to the trade name for chemical vapor deposited polyp-xylylene) polymers.

The described invention addresses a new way of patterning thin films which addresses the shortcomings of approaches used today. The fundamental approach of this technique is to apply a relatively low powered focused beam to dewet the metal from the substrate and effectively write the negative space of the desired design without significant loss of the deposited film mass and little damage to heat sensitive substrates. The laser can be driven by computer aided control to write patterns as needed. A secondary ability of this process allows one to displace the material into adjacent structures thereby building film thickness without the requirement of depositing thicker films.

According to one embodiment, the described invention provides an integrated laser system. The integrated laser system can include, but is not limited to, a single-mode, Yb-doped fiber laser. The Yb-dobed laser, for example, can be capable of outputting a 100 Watt (W) beam at a wavelength of 1070 nm. Deflection of the beam can be achieved, for example, through a computerized scan system fitted with copper mirrors mounted on galvanometer scan motors. Optics for the scan system can include, but are not limited to, an f-theta, telecentric lens with an effective focal length (EFL) of 115 mm, which provides a marking field of 60 mm by 60 mm. By way of non-limiting example, the construction of the lens can allow for a flat focal plane and consistent laser intensity to all parts of the work piece.

According to another embodiment, galvanometer movement and laser control can be performed manually or by a computer. The computer can use custom designed or manufacturer supplied programs.

According to one embodiment, the described invention can use a focused and writable heat source such as a laser beam to induce a localized dewetting of a substrate and a complete migration of material to adjacent areas of a film as driven by surface tension. The described invention also provides “pushing” of material across the surface of a substrate to build height of features that would otherwise require excessive amounts of thin film deposition. According to one embodiment, the dewetting can be “front-side” dewetting. According to another embodiment, the dewetting can be “back-side” dewetting.

According to one embodiment, the described invention provides dewetting of a metal by laser radiation. Characteristics of the metal may include, but are not limited to, a low melting-point, a much higher vaporization-point, a large liquid surface tension value and absorbtion of a relatively large percentage of incident near-infrared (NIR) radiation. Non-limiting examples of suitable metals include bismuth, tin, zinc, gallium, antimony, aluminum, indium and silver. According to one embodiment, the metal is bismuth. According to another embodiment, the metal is tin.

According to one embodiment, the metal is deposited on a substrate. The metal can be deposited on a substrate using techniques known in the art. For example, metal can be deposited on a substrate by chemical deposition or physical deposition. Non-limiting examples of chemical deposition include electrochemical plating, solution deposition, spin coating, chemical vapor deposition, plasma enhanced chemical vapor deposition, atomic layer deposition and the like. Examples of physical vapor deposition include, but are not limited to vacuum assisted approaches such as thermal evaporation, electron beam evaporation, sputtering, pulsed laser deposition, cathodic arc deposition, molecular beam epitaxy, and the like.

Characteristics of the substrate include, but are not limited to, materials with lower surface energy than the metal film, an insulator and reduced absorption of NIR light in order to avoid destruction during laser processing. Reduced absorption of NIR light also allows “back-side” dewetting to occur by transmission of the laser (i.e., NIR light) through the substrate. Non-limiting examples of suitable substrates include parylene-C, parylene-N, parylene-F, parylene D, parylene AF-4, parylene VT-4, borosilicate glass, polyimide (Kapton), polytetrafluoroethylene (PTFE) (Teflon), and polyvinylidene fluoride (PVDF) homodimer (Kynar). According to another embodiment, the substrate is and inorganic such as glass, ceramic, borosilicate glass, silicon oxide, silicon nitride, aluminum nitride. According to another embodiment, the substrate is metal, glass or ceramic substrates coated with a film of parylene.

Through accurate positioning of the laser beam, more complex, directed dewetting towards one side of the beam path can be realized. This in turn can create a variety of shapes and structures. Non-limiting examples of shapes and structures include a line array, a bead, a spiral, circular shapes, metal wells, periodic shapes, polygonal shapes and complex structures. Examples of beads include, but are not limited, single, linear thick beads. Non-limiting examples of periodic shapes include triangles. Non-limiting examples of polygonal shapes include a triangle, a square and a cone. Examples of complex structures include, but are not limited, alphanumeric characters. Alphanumeric characters can include, but are not limited to, letters, numbers, punctuation marks and mathematical symbols.

In addition to the variety of shapes and structures that can be realized through accurate positioning of the laser beam, the described invention allows for cross-hatched geometry characterized by two arrays superimposed upon one another where one is offset at a 90° angle relative to the other. Laser settings of the described invention include, but are not limited to, 50 kHz, 5 μs, 10 Watts (W), 350 mm/s, cover gas at 80 standard cubic feet per hour (SCFH). The dewetted areas can be centered, for example, 75 μm apart with a beam width of 30-35 μm. The absorption layer, for example, can consist of 2.0 μm of bismuth. Low-absorption substrates can consist of, for example, 16 μm of parylene-C polymer on top of 1 mm of borosilicate glass.

The dewetting technique of the described invention can be applied to a variety of technical fields. Such practical applications can include, but are not limited to, flexible and non flexible sensors, electrochemical devices, flexible and nonflexible electronics, neural arrays, electrochromics, electrochemical actuators, artificial muscles, batteries, capacitors, displays, mechanical energy harvesters, micro fluidic devices, artificial eyes, and antennae.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges which may independently be included in the smaller ranges is also encompassed within the invention, subject to any specifically excluded limit in the stated range. Where the stated range includes one or both of the limits, ranges excluding either both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, exemplary methods and materials have been described. All publications mentioned herein are incorporated herein by reference to disclose and described the methods and/or materials in connection with which the publications are cited.

It must be noted that as used herein and in the appended claims, the singular forms “a”, “and”, and “the” include plural references unless the context clearly dictates otherwise.

The publications discussed herein are provided solely for their disclosure prior to the filing date of the present application and each is incorporated by reference in its entirety. Nothing herein is to be construed as an admission that the present invention is not entitled to antedate such publication by virtue of prior invention. Further, the dates of publication provided may be different from the actual publication dates which may need to be independently confirmed.

### EXAMPLES

The following examples are put forth so as to provide those of ordinary skill in the art with a complete disclosure and description of how to make and use the present invention, and are not intended to limit the scope of what the inventors regard as their invention nor are they intended to represent that the experiments below are all or the only experiments performed. Efforts have been made to ensure accuracy with respect to numbers used (e.g. amounts, temperature, etc.) but some experimental errors and deviations should be accounted for. Unless indicated otherwise, parts are parts by weight, molecular weight is weight average molecular weight, temperature is in degrees Centigrade, and pressure is at or near atmospheric.

### Example 1

### Laser System

The integrated laser system consisted of a single-mode, Yb-doped fiber laser (SPI redPOWER R4-HS) capable of outputting a 100 Watt (W) beam at a wavelength of 1070 nm. Deflection of the beam was achieved through a computerized scan system (Scanlab IntelliSCAN 20) fitted with copper mirrors, which were mounted on galvanometer scan motors to allow precise and rapid movement. Acamera system (uEye GigE) for in-situ monitoring of the scribing/dewetting process was mounted in-line with the laser column to allow easier viewing and targeting during operations. Optics for the scan system consisted of an f-theta, telecentric lens with an effective focal length (EFL) of 115 mm, which provides a marking field of 60 mm by 60 mm. The construction of the lens allows for a flat focal plane and consistent laser intensity to all parts of the work piece. The laser column was mounted over a custom weld substrate holder fixture that consisted of a custom designed 2-axis tilt-leveling stage and a manually adjustable Z-axis control to allow adjustment of the beam diameter seen by the material. All galvanometer movement and laser control was performed by a computer using manufacturer supplied programs.

### Example 2

### Substrate Preparation

Borosilicate glass slides (VWR microscope slides) provided the underlying substrate for all samples. These slides measured 25.4 mm×76.2 mm×1.0 mm and arrived pre-cleaned. Parylene-C (par-C) (Specialty Deposition Systems, PDS 2010) was deposited on the slides at a nominal thickness of 22 μm±1 μm. Average surface roughness (Ra) of deposited par-C varied between 22 and 35 nm. Unmasked metal deposition upon both glass and par-C substrates was carried out using high vacuum thermal evaporation. Samples were kept under an inert argon (Ar) atmosphere until immediately prior to laser exposure and were stored in an inert atmosphere immediately following exposure until characterization was performed.

### Example 3

### General Laser Parameters

Laser power was held at its lowest operating limit of 10 W for all target metals and substrates to minimize thermal degradation. At the focal plane of the lens, the beam spot's diameter (Dₛ) was calculated using Equation 4, where f is the focal length of the lens, λ is the laser wavelength, D_{B} is the full-width, half-maximum (FWHM) beam diameter measured as it enters the lens, and M² is the beam quality factor describing the shape of the intensity distribution (where M=1 for perfect Gaussian distributions).

Dₛ=1.27*f*λ*M²/D_{B} (4)

The laser system was operated in a single-mode (TEM₀₀) fashion, with M²<1.1 and produced a 5 mm±0.5 mm wide beam at its exit aperture. The beam had a divergence<0.4 mrad and entered the lens aperture with a diameter of 5.07 mm. Calculation of the spot diameter yielded 33 μm. Measurement of the width of the dewetted area resultant from a single pass of the beam confirmed the diameter calculation. Exposures of larger areas were carried out by scanning the beam across the surface of the target metal. The top-down edge profile of a single, dewetting pass can depend on a number of variables, including laser absorbance, thermal conductivity, solidification rate and thickness of the target metal. Pulse overlap can also influence the edge profile of the dewetted area as viewed from a top-down angle, where low overlap percentage can produce a scalloped edge. The overlap parameter was calculated using Equation 5, where V is the scan speed, f is the pulse frequency, T is the pulse length, and S is the spot size [Torkamany, M. J., et al., “The effect of process parameters on keyhole welding with a 400 W Nd:YAG pulsed laser,”Journal of Physics D: Applied Physics. 39 (2006) 4563-4567]. On bismuth targets measuring 1.6 μm in thickness, an overlap exceeding 75% was found to avoid a scalloped edge profile along the dewetted area. Pulse frequency and length were kept constant at 50 kHz and 5 μs respectively, while the beam was scanned at 240 mails. Under the described conditions, the calculated overlap was 86%.

O_{f}=[1−(V/f)/(S+VT)]×100 (5)

Tin targets measuring 1.6 μm in thickness require a greater degree of overlap to avoid a scalloped top-down edge profile. Laser pulse frequency and length were held constant at 50 kHz and 5 μs respectively, while scan speed was conducted at 100 mails to achieve a calculated overlap of 94%. To prevent significant amounts of oxidation within the dewetted material, an argon gas blanket flowed at 80 standard cubic feet per hour (SCFH) over the sample during dewetting cycles. Pulse shaping corrections were enabled to prevent the spike in delivered power; a characteristic of the laser's first pulse. For dewetting geometries consisting of multiple passes or segments, the scanner's positioning speed was set equal to the marking speed designated for that metallic target.

### Example 4

### Compatibility of Different Low-Absorption Substrates

The compatibility of different low-absorption substrates under the described selective dewetting process were demonstrated (FIG. 9). FIG. 9A demonstrates the ability to use a 1 mm borosilicate glass substrate in a selective dewetting writing process. Due to the relatively high melting temperature and the low absorption of the glass with respect to infrared (IR) laser radiation, the substrate was left unmodified by the laser radiation. The absorption layer consisted of 1.5 μm of Bismuth metal. FIG. 9B shows an example of the dewetting phenomenon using a 16 μm thick parylene-C polymer substrate in between the absorptive, 1.5 μm Bismuth, and the 1 mm borosilicate glass. In this case the polymer is parylene-C. Dewetting was clearly visible, even if the absorptive material solidified differently between the two substrates. The laser settings for both substrates were: 50 kHz, 5 μs, 10 W, 238 mm/s, cover gas at 80 SCFH. The lines are centered 110 μm apart.

### Example 5

### Basic Laser Directed Dewetting

To Explore the basic, laser-induced dewetting properties of bismuth (Bi), arrays of 150 μm wide dots were deposited on uncoated glass slides and parylene-C (par-C) coated slides. Bismuth metal was deposited in a dot-array pattern using a masked, vapor deposition technique. Deposited dots were centered 2.15 mm apart in a 9×13 dot array. Two such arrays were deposited upon each substrate. Substrates consisted of uncoated borosilicate glass microscope slides, as well as slides with a 22 μm thick deposited layer of par-C. Each dot had a diameter measuring 130 μm. Dots were deposited at three different thicknesses: 1000 nm, 2000 nm, and 4000 nm. As a result of shadowing effects from the masked deposition, each dot exhibited excess deposited material outside of the 130 μm diameter. This excess material tapered down in thickness and extended out to a maximum diameter of 150 μm+2 μm. Exposure of the deposited dots proceeded in a spiral pattern starting at an outer diameter of 300 μm and decreased with a spacing of 20 μm down to an inner diameter of 70 μm to ensure complete exposure of the deposited dots. The center of the spiral pattern and the center of the deposited dot were aligned to within 10 μm. Laser settings were set at the standard laser parameters for bismuth (e.g., pulse frequency=50 kHz; pulse length=5 μs; power=10 W; scan speed=240 mm/s; positioning speed=240 mm/s; Ar gas flow=80 SCFH).

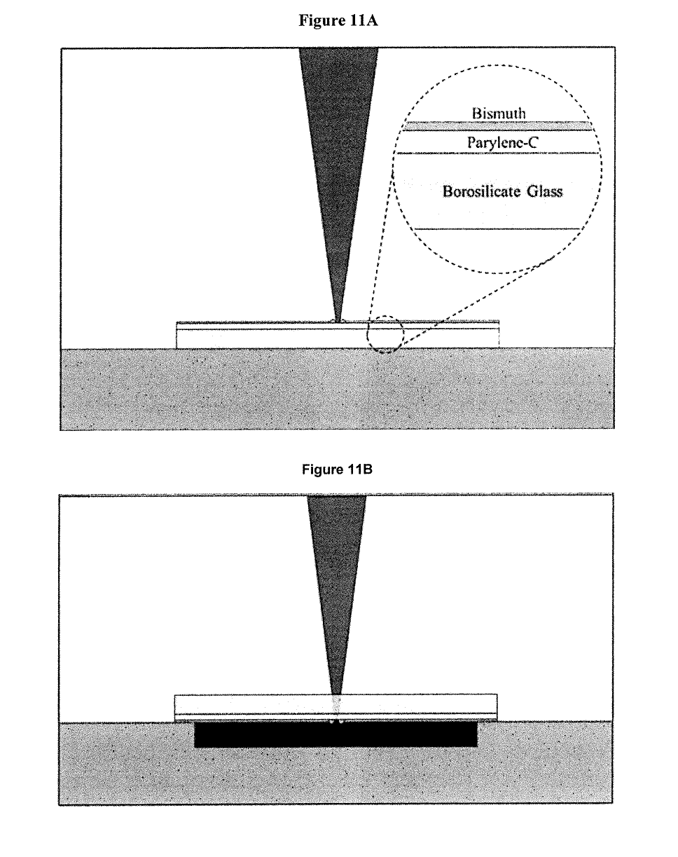

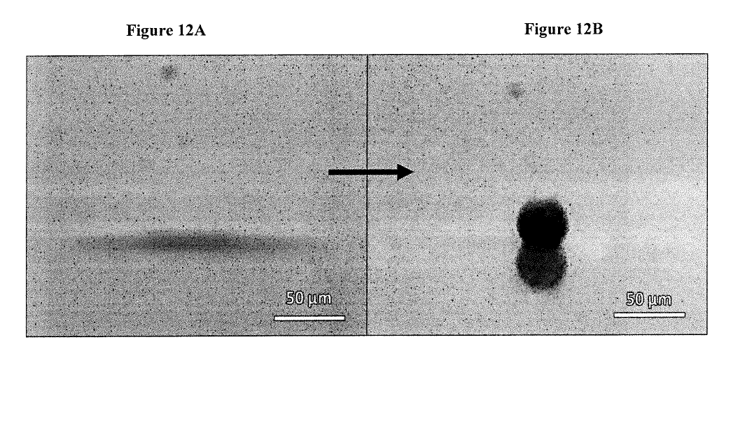

Beginning at a distance of 150 μm from the center of the dot, the beam was scanned in a spiral pattern along the surface of the deposited metal. Each complete turn along the spiral path brought the beam 20 μm closer to the center of the dot until it reached a radius of 35 μm. As the laser spot progressed along the proscribed path, the light coupled with the metal induced melting and retraction into a single dewetted mass located at the center of the spiral (FIG. 12). Attempts to end the spiral path of the beam at smaller radiuses resulted in complete detachment of the dewetted mass, which was blown off the substrate by the flowing argon blanket. The radius of the dewetted mass itself measured 18 μm wide when viewed from a top-down angle. This is notably smaller than the radius down to which the laser was scanned, but can be explained by the radius of the laser spot itself. The calculated laser spot diameter was 33 μm, which indicated that laser energy reached a distance from the dot center as small as 18.5 μm. A side-view of the dewetted mass revealed an almost-spherical geometry (FIG. 12B).

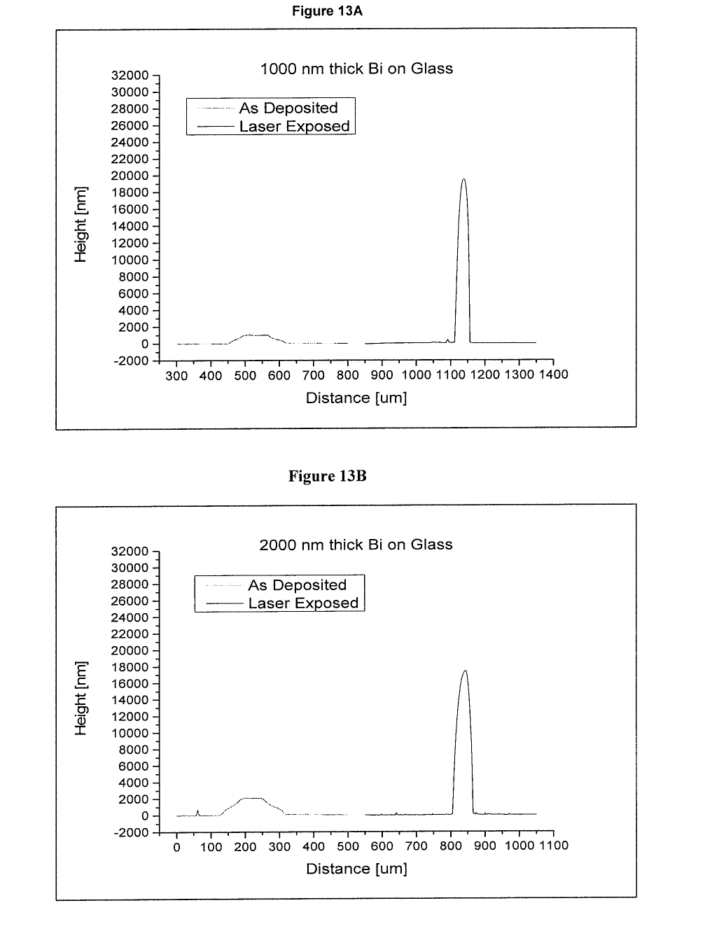

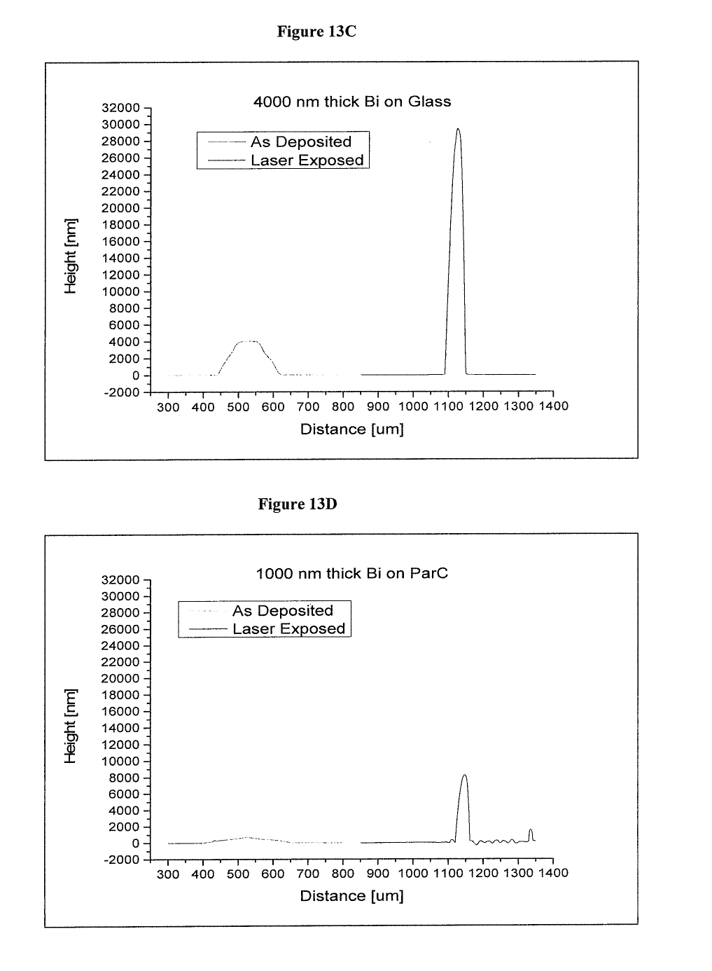

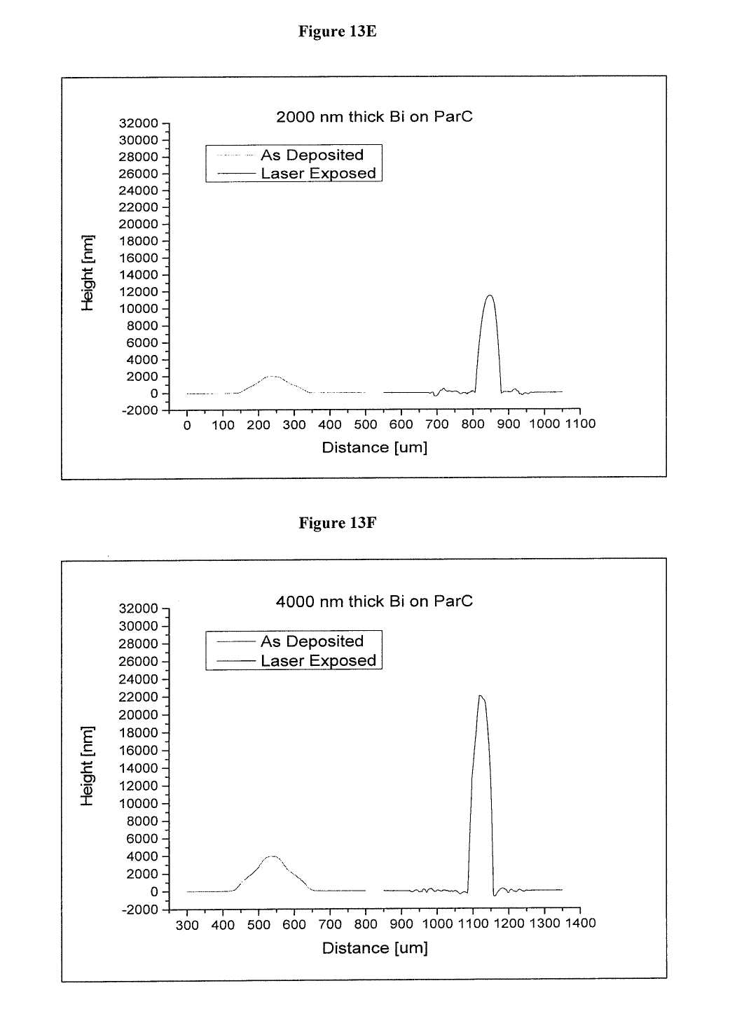

Profilometry measurements of the dewetted masses revealed the extent of dewetting via the difference in height between the “as deposited” and the “laser exposed” conditions of the dots (FIG. 13). For dots deposited upon uncoated borosilicate glass, the resulting heights in the dewetted mass did not systematically increase with the as-deposited thickness. Dots deposited at 1000 nm, 2000 nm, and 4000 nm dewetted to heights of 19500 nm, 17500 nm, and 29250 nm respectively (FIGS. 13A, B and C). When deposited on par-C coated slides, the measured heights held a systematic, positive correlation with volume increase. Dots deposited at 1000 nm, 2000 nm, and 4000 nm dewetted on par-C to heights of 8750 nm, 11500 nm and 22000 nm respectively (FIGS. 13D, E and F).

### Example 6

### Simple Dewetting Geometry

Line Arrays

Features organized into parallel lines represent a fundamental geometry in modern electrode and electronics design. Viable patterning techniques must be able to accurately and reproducibly create such structures out of the target material. To this end, an array of isolated, parallel lines were dewetted from Bi thin film deposited on 1 mm borosilicate glass slides coated with par-C as a substrate, as well as from tin thin film deposited on 1 mm borosilicate glass slides coated with par-C as a substrate.

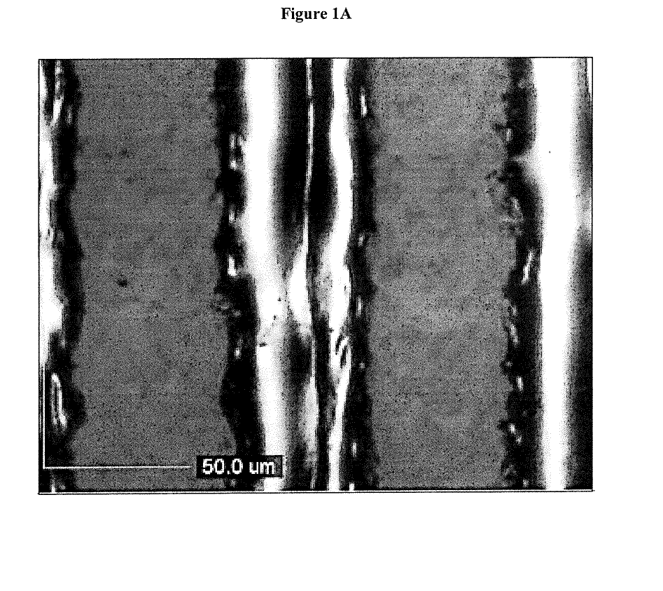

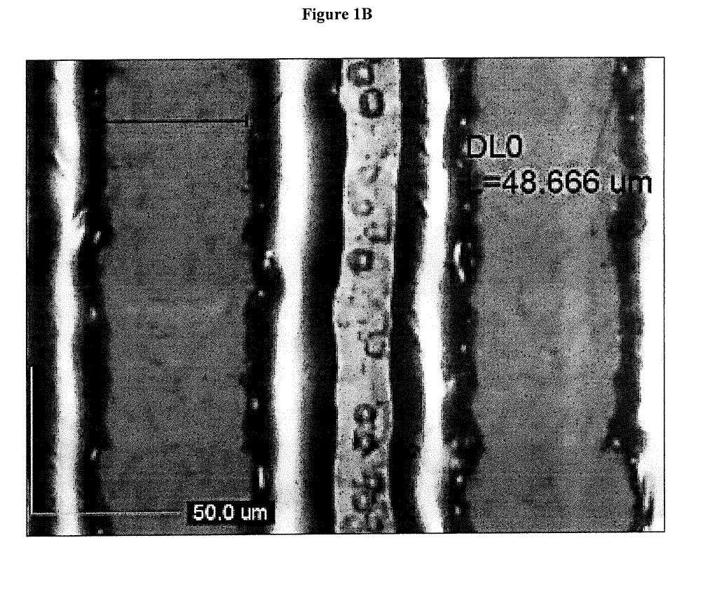

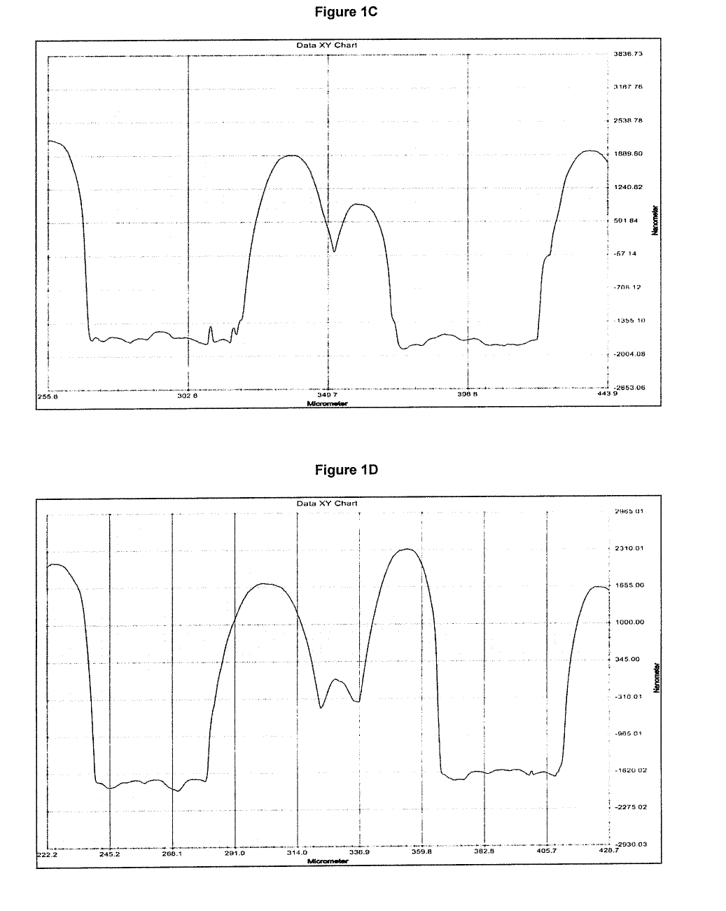

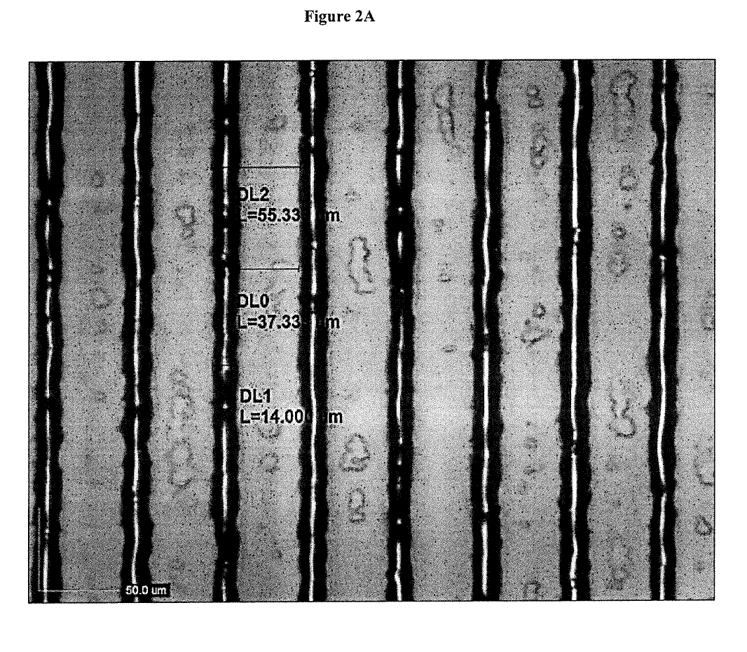

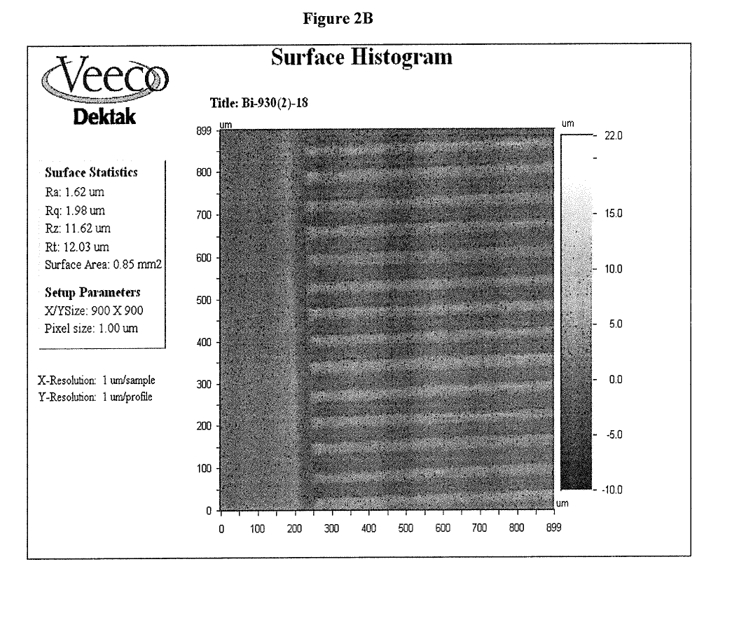

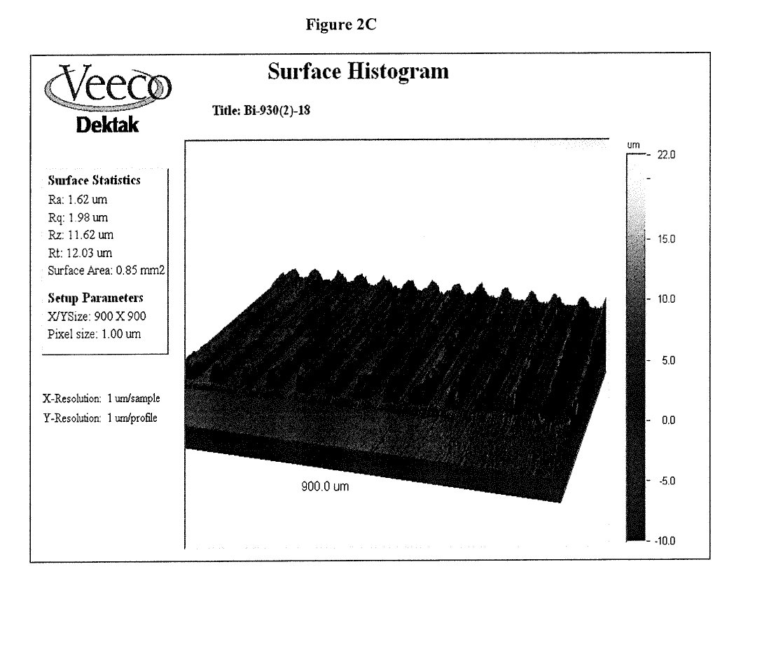

Tests on 1500 nm bismuth metal coated substrates fabricated by thermal evaporation demonstrated the laser system's ability to construct isolated lines of dewetted metal. FIG. 1 shows isolated lines of material created by dewetting areas on either side. The lines were constructed using a 10 W pulsed beam at 50 kHz, a pulse length of 5 μs, and a speed of 350 mm/s. A noble-gas cover blanket (argon) was flowed over the material at 80 SCFH. The centers of the dewetted lines were spaced at 100 μm (FIG. 1A) and 125 μm (FIG. 1B) respectively with a beam spot diameter of 40 μm. In both examples, the absorption layer consisted of bismuth with a thickness of 1.5 μm. The low-absorption substrates consisted of 16 μm of deposited parylene-C polymer on top of a 1 mm thick borosilicate glass slide.

Use of the scanner head allowed for the creation of arrays of lines with user-defined spacing. Laser parameters were set such that the pulse overlap was sufficient to dewet enough material between the lines to ensure electrical isolation. To verify this, resistance measurements were taken with an Agilent 34410A Digital Multimeter. All lines with a pulse overlap percentage above 45% showed resistance values equivalent to an open circuit (displaying “overload”>>G-Ohm), indicating that there was no residual material between adjacent lines to allow any appreciable electrical conduction. The laser parameters were as follows: 50 kHz, 5 μs, 10 W, 350 mm/s, cover gas at 80 SCFH. Lines were centered 55 μm apart. The sample consisted of a 1.5 μm thick layer of Bismuth on top of 16 μm of parylene-C polymer with a 1 mm thick borosilicate glass substrate.

Bi films measuring 1.6 μm thick deposited on 1 mm borosilicate glass slides coated with between 25 and 30 μm of par-C as a substrate were exposed to laser radiation in a set of line arrays. Exposure conditions mirrored the general laser parameters for bismuth films under focused conditions (e.g., pulse frequency=50 kHz; pulse length=5 μs; power=10 W; scan speed=240 mails; positioning speed=240 mm/s; Ar gas flow=80 SCFH). The substrate was oriented with the metallic film facing the scan lens, which is characterized as a “front-side” dewetting condition. Each array encompassed the area of a 2 mm×2 mm square. Spacing between individual lines within the arrays measured as large as 200 μm and were incrementally decreased down to a pitch of 55 μm for bismuth films.

Tin films also were exposed in line array patterns in similar fashion. Specifically, tin films measured 1.6 μm in thickness and were deposited on 22 μm par-C/1 mm borosilicate glass substrates. Scanning and positioning speed were set at 100 mm/s. Line arrays were scanned using various pitches ranging from 200 μm down to 75 μm. Exposure settings mirrored the general laser parameters for tin films, which were identical to those for bismuth films, with the exception of the scan and positioning speeds. For tin films, line arrays with a pitch of 100 μm were further processed under defocused laser conditions. A defocused beam spot 150 μm in diameter, as measured by marks made on target films, was created by lowering the holder 10 mm below the focal plane of the lens. The laser operated at 10 W, 10 kHz, with pulse durations of 40 μs. The beam scanned at 1400 mm/s, which resulted in a pulse overlap calculated at 34%. Overlap was minimized to prevent over exposure and uncontrolled, random dewetting of the film.

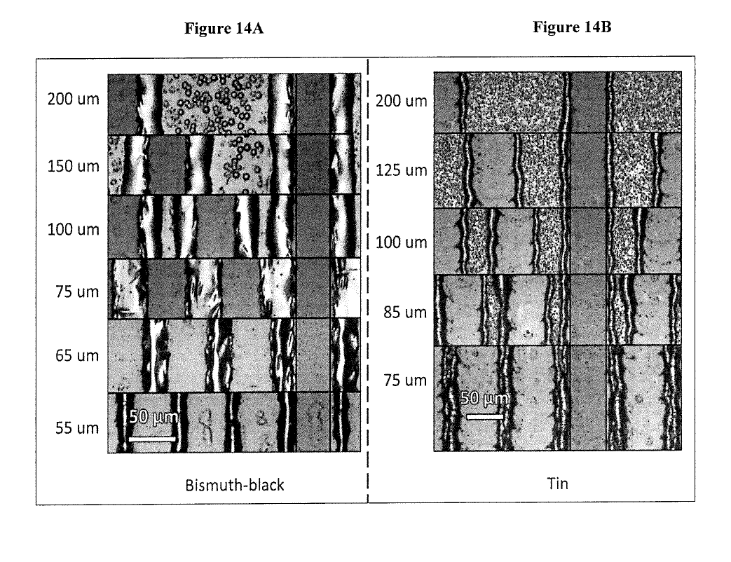

Each pass of the laser created an area of exposed substrate. Dewetted metal gathered along the edges of the exposed area, to create a dewetted bead. Height measurements of the dewetted bead showed a marked increase in the metal thickness compared to the original layer thickness. Profilometry measurements placed the height of the dewetted bead at 3.4 μm as measured from the substrate, which represented a 113% increase in the local thickness of the film. FIG. 14 displays line arrays created using both bismuth and tin films. Lines were created at various pitches, yet the areas of exposed substrate remained the same widths due to a consistent beam spot diameter. Without being bound by theory, a single laser pass was assumed to distribute an equal amount of dewetted material to both sides resulting in each bead being comprised of half the material dewetted from an individual laser pass. With a height of 3.4 μm and a width of 25 μm, the height to width aspect ratio of a single dewetted bead in the bismuth film was calculated as 0.13:1.0. Dimensions of the dewetted beads remained relatively constant until line pitch decreased down to 75 μm. Profilometry data (FIG. 15) showed that when line pitch was set at 75 μm on a bismuth film, the dewetted beads made from adjacent laser passes combined into a single 3.85 μm thick, 35 μm wide bead. Further reduction in pitch down to 55 μm resulted in a single 6.67 μm thick, 14 μm wide bead (FIG. 16). Aspect ratios of the 75 μm and the 55 μm spaced line arrays were 0.11:1.0 and 0.48:1.0 respectively. Further characterizations of the line arrays by scanning electron microscope confirmed these measurements (FIGS. 15 and 16).

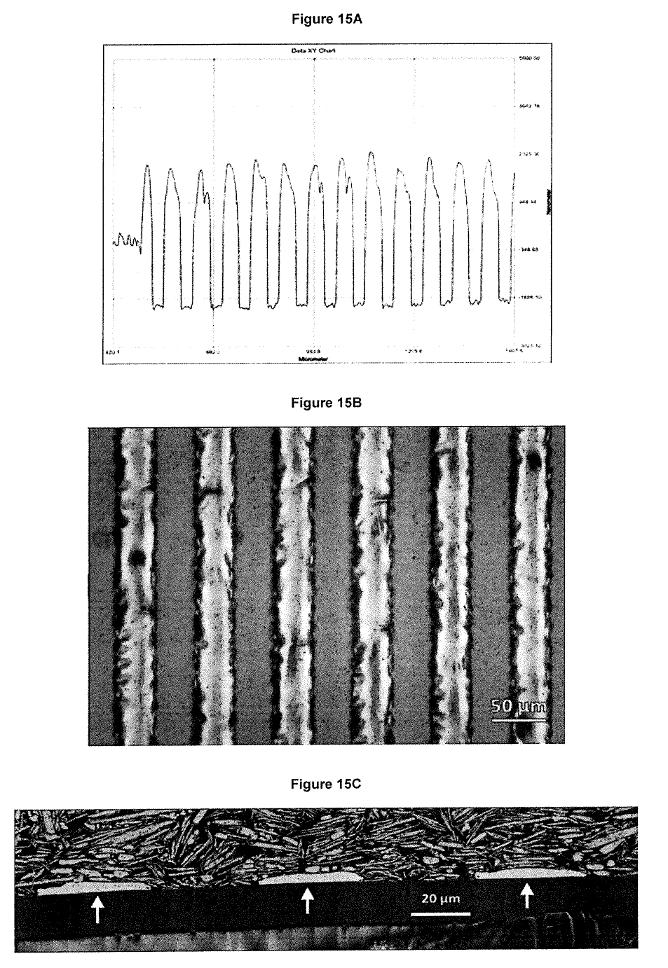

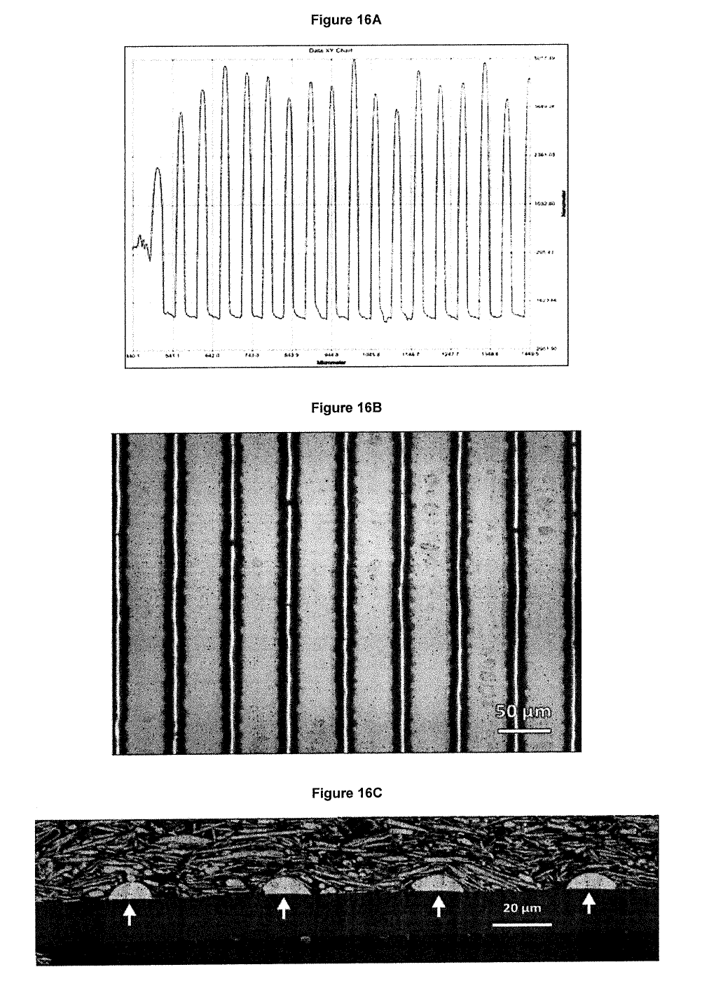

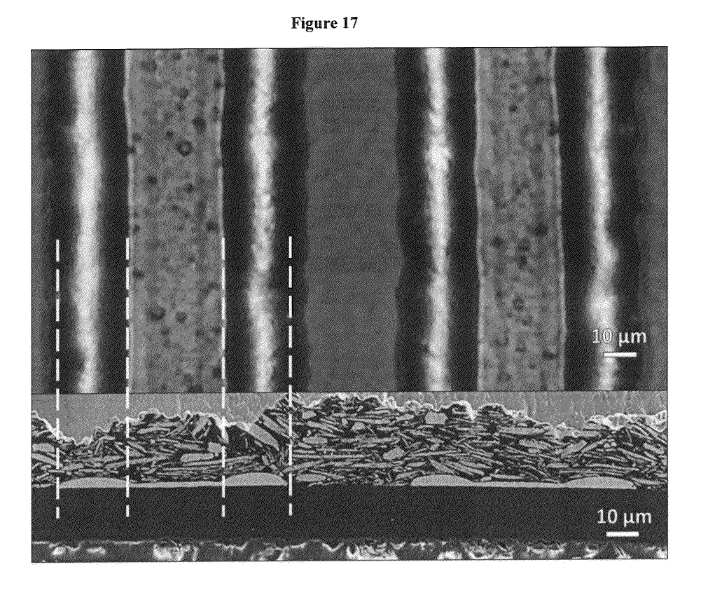

For those line arrays with line spacing larger than 75 μm, each dewetted bead remained detached from one another. The cross-sections for these types of line arrays showed an area of exposed substrate with no obvious residual film bordered on both sides by two dewetted beads created from the film that once filled the space. Beyond the two beads were areas of as-deposited film, which were followed by a second pair of dewetted beads created from adjacent laser passes. FIG. 17 shows such cross-sections, where beads from adjacent laser passes are connected by a section of as-deposited film. In FIG. 17, the white dash-lines are used to identify equivalent structures as seen from both a top-down angle and a cross-sectional perspective. In this respect, these structures form channels. Without being bound by theory, these types of line arrays could be useful in microfluidics applications as they effectively form micro-channels of conductive material.

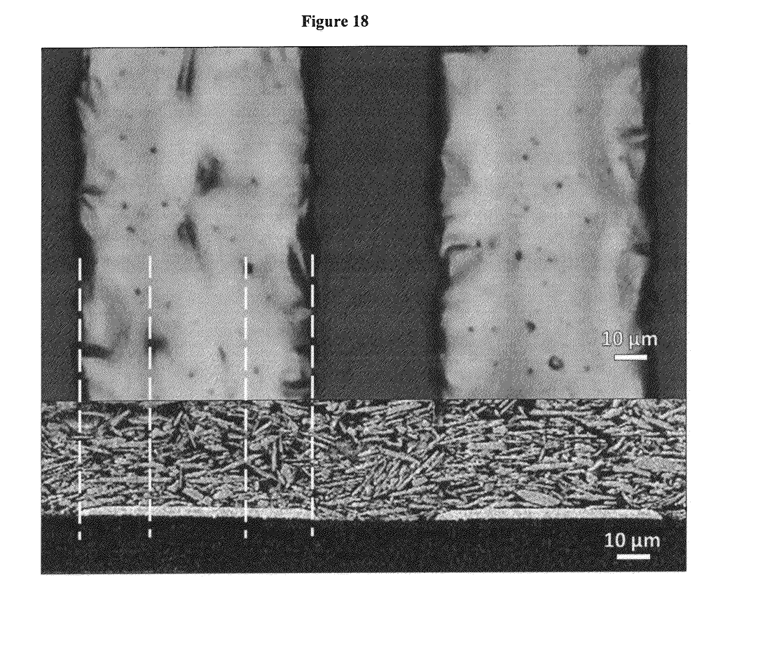

Defocused reprocessing conditions led to an annealing effect on the dewetted beads, resulting in a smooth cross-section. Initially, beads measured 3.4 μm in thickness. As the beads melted, they recombined with each other by flowing over the as-deposited section of film that connected them. In direct comparison to the cross-sections in FIG. 17, the re-melted features in FIG. 18 exhibit a uniform cross-sectional height. White dash-lines demark the former locations of the dewetted beads. Inspection of the re-processed features showed a decrease in thickness in the former locations of the dewetted beads with a corresponding increase in thickness in the former as-deposited area. Profilometry scans revealed that the 3.4 μm thick beads were melted and flowed into the 1.6 μm connecting film-section to form wide, uniform lines that measured 2.6 μm thick.

Material Retention

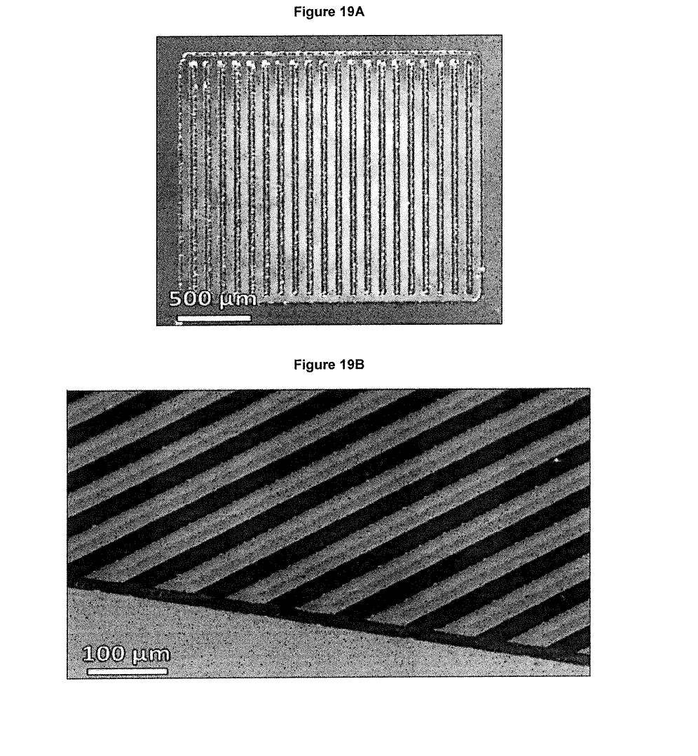

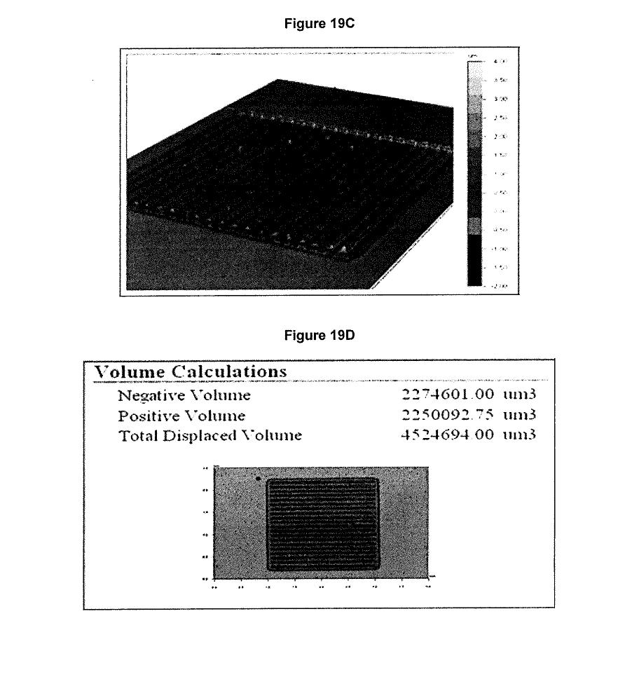

In this study, profilometry was used to establish an accounting of the material volume before and after analysis and thus establish whether significant metal ablation occurred. An accounting of the displaced volume of a dewetted line array was conducted using a Dektak profilometer. A 3.9 mm×2.5 mm area encompassing a line array with a pitch of 100 μm was scanned using the profilometer to create a 3D map. The line array itself measured 2 mm×2 mm. Height sampling of the array was set such that individual readings were spaced one micron (1 μm) apart in both the X and Y directions. Volumetric analysis was conducted using Dektak's Veeco data analysis program. Baseline was taken as the film surface, with measurements above and below baseline designated as positive and negative respectively. For example, a process that conserves the material completely would result in positive and negative volume measurements cancelling out (FIG. 19).

An isolated array of lines was scanned into a 1.6 μm thick Bi film deposited upon a par-C coated borosilicate glass slide. The par-C layer measured 25 μm thick. General lasing parameters for Bi were used as described in Examples 5 and 6. The entire array measured 2 mm×2 mm and had a line pitch of 100 μm. Using successive, adjacent profilometer scans, a 3D model of the area was formed and analyzed. Based on profilometer scanning, it was determined that a total of 4.52×10⁶ μm³ of material was displaced from the baseline. Of this volume, only 2.45×10⁴ μm³ or 0.5% of the displaced volume was unaccounted. This amount of unaccounted material falls within the measurement error of the profilometer and indicated minimal loss of the material into the vapor stream. Notably, the entire line array featured in FIG. 19 took 0.316 seconds to complete; with much of this time spent on timing delays between marking and mirror-positioning steps. These results suggest that for geometries that feature large amounts of mirror re-positioning, the majority of the processing time is spent accommodating delays between scanner command signals, mirror reaction times, and laser activation timing. Such timing delays can be reduced by improvement of the galvanometer motors to which the mirrors are mounted as well as further optimization of the marking protocols and geometries within the scanner software.

Back-side Exposure

Front-side” dewetting of thin films refers to the exposure of the bismuth layer through the Ar gas blanket (FIG. 11a). In studies assessing the waveguide properties of par-C, transmission in the 1000 nm to 1500 nm range through a 15 um thick sample was cited as 85%; the rest of the radiation is either absorbed or reflected [Jeong, Y. S., et al., “UV-visible and infrared characterization of poly(p-xylylene) films for waveguide applications and OLED encapsulation,” Synthetic Metals. 127 (2002) 189-193]. Choosing substrates with minimal absorption of near-infrared (NIR) laser radiation allows for “back-side” processing of the target by transmission of the laser through the substrate. Minimal differences appear in the exposed areas of substrate created by front-side dewetting when compared to back-side dewetted samples. By directing the beam through the low-absorption substrate, dewetting can be initiated through underside exposure (i.e., back-side exposure). By this technique, more variation in target fixturing can be realized.

Exposure of bismuth samples proceeded in a “back-side” configuration where laser light was directed through the substrate before interacting with the metallic layer (FIG. 11b). Under this configuration, a simple line-array with line spacing of 200 μm was dewetted from the 1.6 μm-thick metallic layer. The target stage was adjusted accordingly to ensure that the bismuth layer was within the focal plane of the lens. Laser settings were set to match the general laser parameters for bismuth samples as described in Examples 5 and 6. A shallow relief milled into the welding stage prevented transfer of the dewetted material onto the underlying support as diagramed in FIG. 11b. The relief also ensured that the dewetted bismuth had sufficient room to dewet and accumulate on the par-C/bismuth interface in an unhindered manner.

Profilometry analysis revealed no significant difference in resulting cross-sectional thickness of the dewetted materials. Measurements made under optical microscopy revealed a consistent width of 30 μm for the dewetted areas regardless of exposure side. This is consistent with literature evidence of low absorption of NIR light for both par-C and borosilicate glass substrates. Significant amounts of beam attenuation through the substrate or reflection by material interfaces would have resulted in decreased trench width as beam diameter is partly a function of intensity while in the focal plane. Additionally, there was no considerable difference between the samples with respect to beam damage of the substrates, nor was there any need to adjust laser exposure settings. The role of gravity in bismuth dewetting appeared negligible at these length scales, as there was no significant increase to the average height under back-side dewetting.

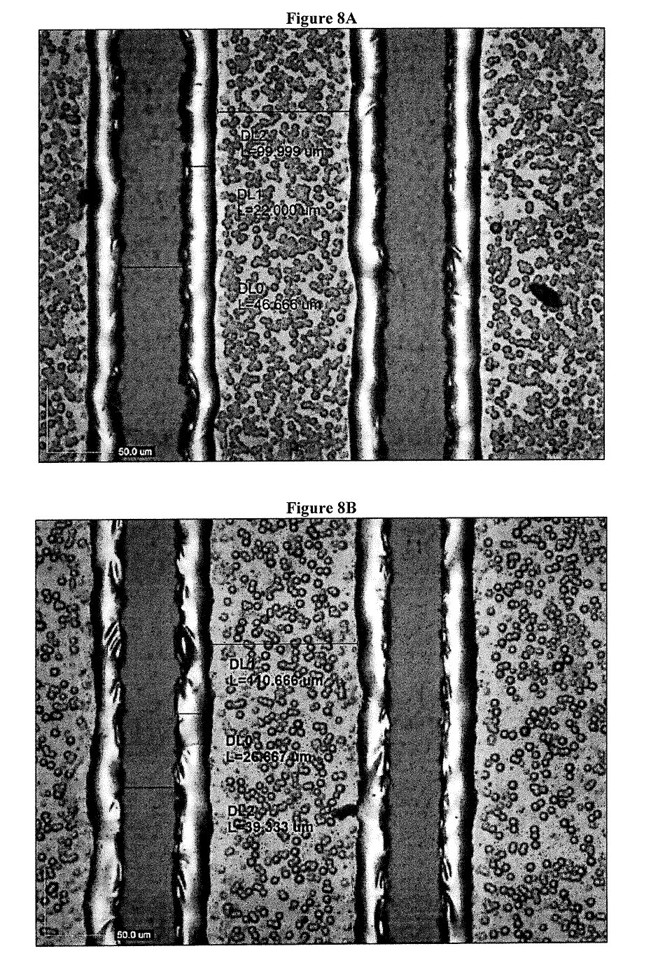

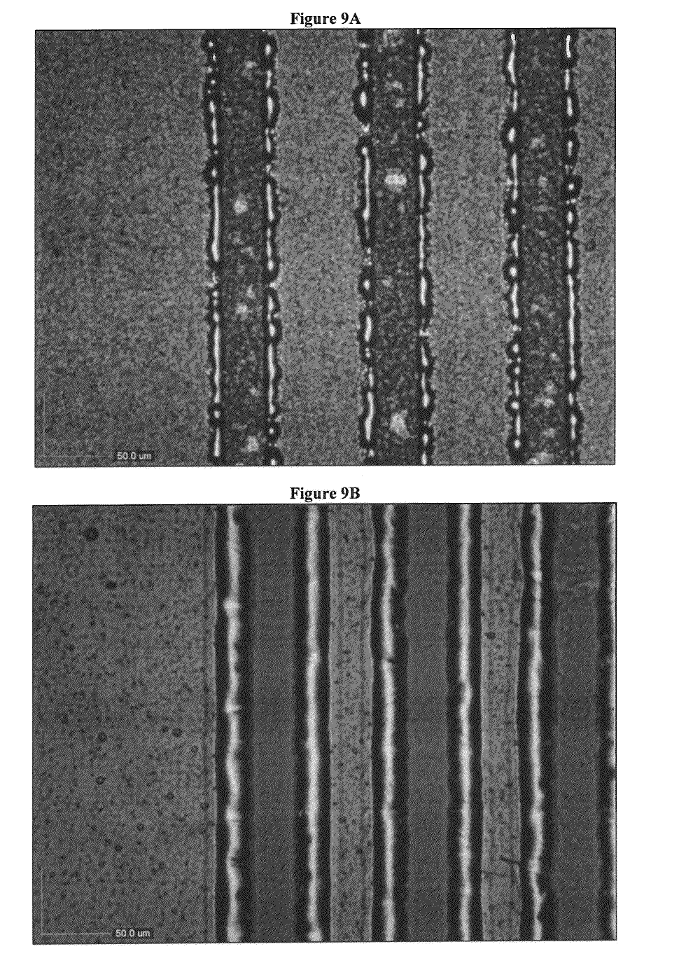

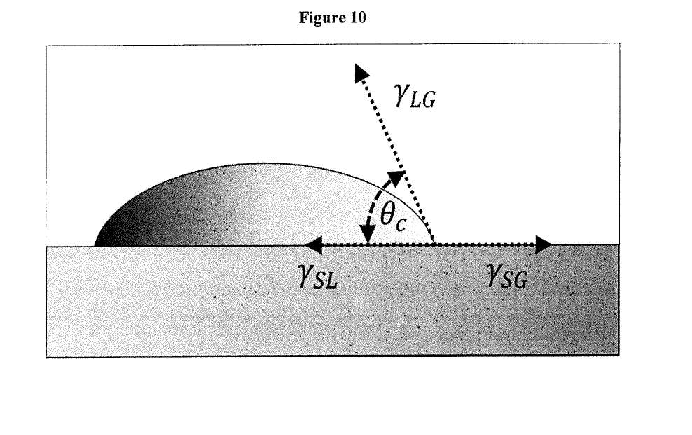

FIG. 8 shows a comparison between “front-side exposure” and “back-side exposure.” FIGS. 8A and 8B each show two dewetted lines that are centered 200 μm apart. Laser settings for both samples were as follows: 50 kHz, 5 μs, 10 W, 350 mm/s, cover gas at 80 SCFH. Both trials were performed on the same slide, which consisted of 1.5 μm of bismuth. The low-absorption substrate consisted of 16 um of parylene-C polymer on top of 1 mm of borosilicate glass. FIG. 8A was constructed using exposure of the top surface or “front-side patterning” and FIG. 8B was constructed using exposure of the underside through the low-absorption substrate or “back-side patterning.” Both approaches were successful and exemplified the ability to form structures through a material. Without being bound by theory, as no material was ablated forming a vapor, one can apply this writable technology to enclosed structures as long as the outside media is mostly transparent to the wavelength of the laser beam.

Accumulated Structures

When a target material (e.g., bismuth) melts and dewets from a substrate, rather than ablating away, the target material can be directed and “pushed” into larger and larger aggregate structures. To explore the accumulation behavior of dewetted metal deposited on par-C, multiple, closely-spaced scanner passes were used to successively melt an ever growing amount of material. The overall shape of the accumulated structure was designed as a single, linear, thick bead of dewetted bismuth. The initial film used was a 1.6 μm thick film of Bi deposited upon a 22 μm par-C/1 mm borosilicate glass substrate. Scanning line pitch for the accumulated structure was set at 20 μm and caused the dewetting metal to dewet in the direction of the advancing line front. In total, the accumulated line consisted of 36 scanner passes—18 passes on each side of the line, which “pushed” material towards the middle and combined to create one structure. General laser parameters for bismuth samples as described in Examples 5 and 6 were used for each scanner pass.

FIG. 6 provides an example of such a built up structure along with profilometer data for height measurement. The laser settings used were as follows: 50 kHz, 5 μs, 10 W, 350 mm/s, cover gas at 80 SCFH. The “push” lines were centered 45 μm apart to leave a line measuring 40-50 μm wide and 31.6 um high. This structure was created from a 2.0 μm thick layer of bismuth metal on top of 16 μm of parylene-C polymer and 1 mm of borosilicate glass.

FIG. 20 presents a single line that was formed by scanning the laser across the surface of a Bi film deposited upon a par-C covered surface. Pitch was set at 20 μm. At such a small pitch, the dewetting metal preferentially accumulated on the same side as the direction of advancing laser passes. For this example, an initial set of 18 lines were dewetted, with the lines advancing left to right. A second set of 18 lines were dewetted, with the lines advancing from right to left. The second set of lines was placed in such a position so that the end of the final line would be positioned parallel to the end of the first set of lines. This caused the accumulated metal to combine and form one, very thick structure. The formed structure was itself a linear feature and measured 29.9 μm high, nearly 1900% as thick as the original 1.6 μm thick Bi film. With a width measurement of 56 μm, the feature had an aspect ratio of 0.53:1.0.

Alternate geometries of dewetted Bi were realized in the form of spirals. A spiral with a 2 mm outer diameter, a 200 μm inner diameter, and a spiral branch distance of 20 μm was dewetted from the metallic layer. Profilometry was used for volumetric analysis of the accumulated material at the center of the spiral. An identical accumulated structure was created from a 1.6 μm tin film using the general laser parameters for tin films as described in Example 5.

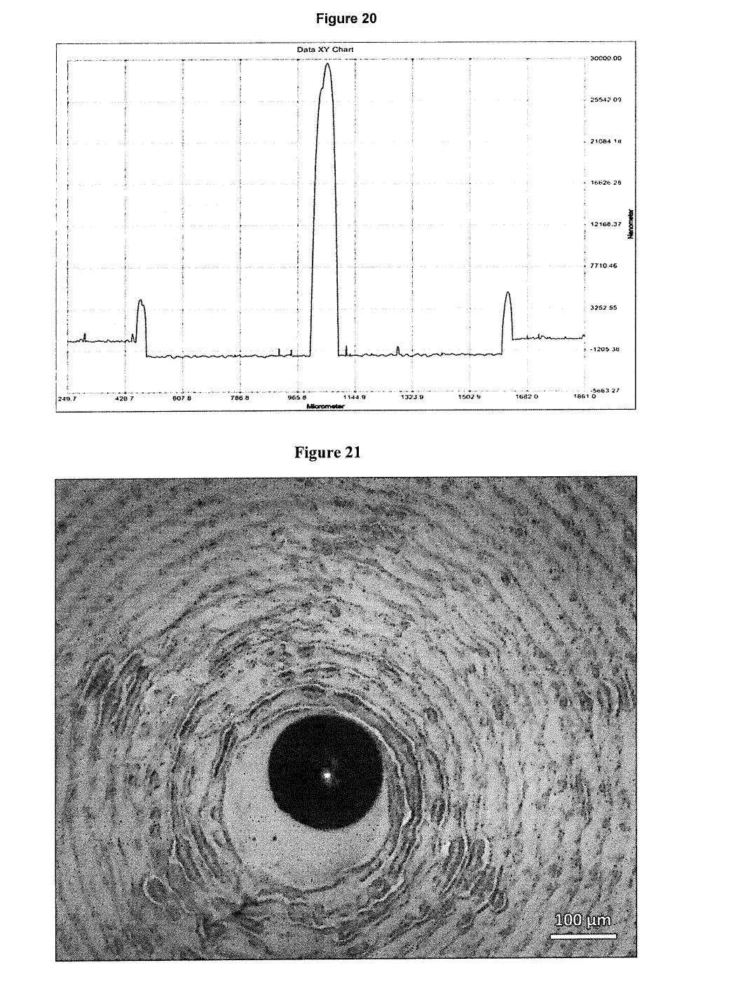

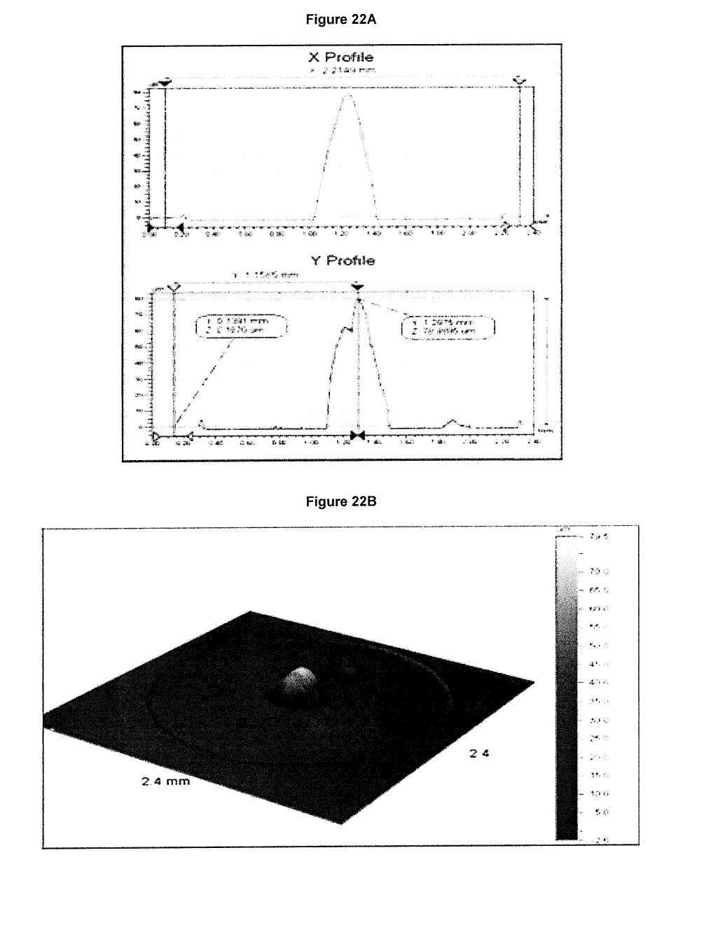

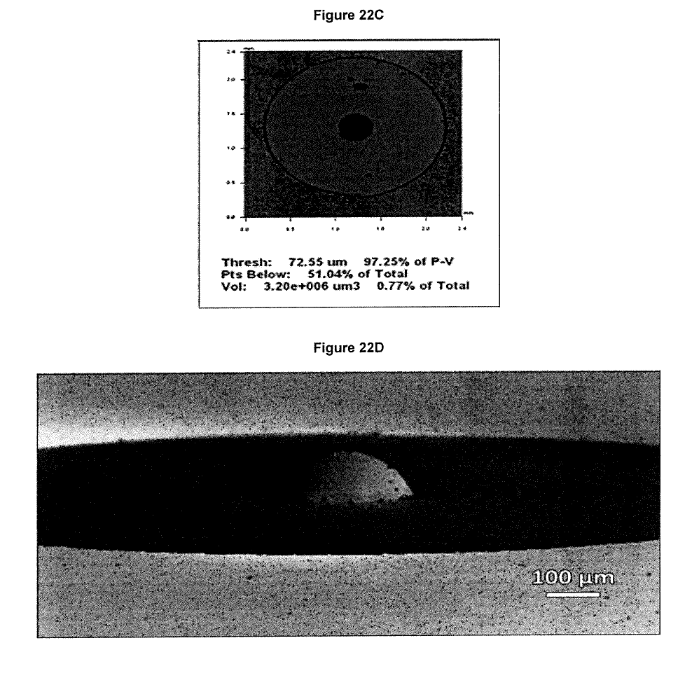

Spiral dewetting of a 1.6 μm thick Bi film produced a single, large, hemispherical accumulation in the center of the spiral. The spiral pattern began at a radius of 1 mm, where every 360 degrees along the spiral path brought the laser spot 20 μm closer to the center. Marking along the spiral path stopped once the laser reached a radius of 150 μm. The resulting feature measured 79 μm tall, a total 4900% thicker than the original 1.6 μm thick film. The diameter of the accumulation was measured at 160 μm, which gave an aspect ratio of 0.49:1.0. Total time for formation was 0.669 seconds. In total, the spiral had 42.5 layers of dewetting passes combined into one large accumulation. Volumetric analysis was performed on this spiral dewet pattern (FIG. 22). FIG. 22 shows the computed displaced volume as 9.6×10⁶ μm³ with a total of 2.6×10⁵ μm³ of unaccounted negative volume. This 2.8% discrepancy indicates that multiple laser exposure passes during the material “push” did not introduce significant amounts of ablation. Tin also dewet easily under a spiral exposure (FIG. 21). After laser exposure, the agglomerate at the center of the spiral measured 131 μm thick with a diameter of 200 μm, which translated to an aspect ratio of 0.66:1.0; the highest aspect ratio achieved (FIG. 21).

### Example 7

### Complex Dewetting Geometry

Periodic Shapes

The laser system of the described invention allows for detailed and complex patterning of film. In this study, the laser system's galvanometer scanner system was used to create periodic shapes on film targets.

Periodic shapes were realized on 1.6 μm thick bismuth targets deposited upon 22 μm par-C/1 mm borosilicate substrates. Laser settings matched the general laser parameters for bismuth films described in Examples 5 and 6. Within the confines of a 1 mm by 1 mm square, dewetting scanner passes were conducted with a pitch of 100 μm in both the X- and Y-directions. The resulting square structures were then dewet along the diagonals to create triangular structures.

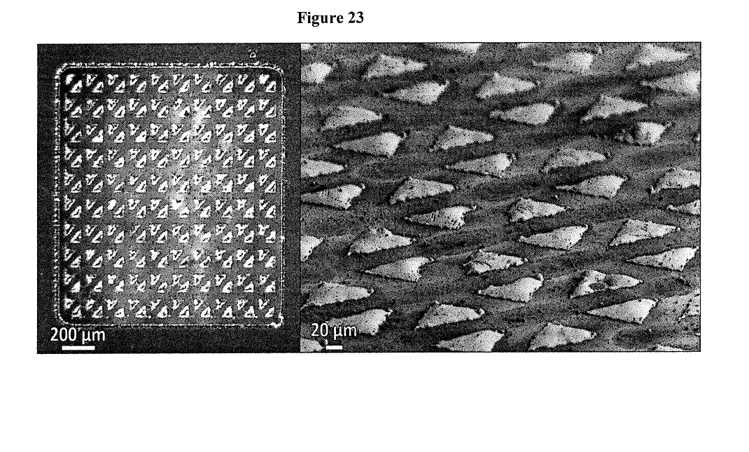

Measurements of the features formed from a 1.6 μm thick Bi film revealed triangular dimensions of 70 μm×70 μm by 100 μm. At the designed dimensions, the features agglomerated together to make a continuous structure without any residual as-deposited film visible (FIG. 23). The thickness of the features was measured as 3.2 μm from a 1.6 μm film. Each feature remained disconnected from one another and exhibited little variation in dimensions.

Polygonal and Circular Accumulated Structures

Angles and corners present a particular challenge for dewetting, especially when building structures in height. In order to demonstrate the ability of the described laser scan system and dewetting technique to form angles and corners, non-functional polygonal and circular structures were created on a film target.

Accumulation processing techniques were used to create non-functional polygonal and circular structures (e.g., a triangle, a circle, a square and a cone).

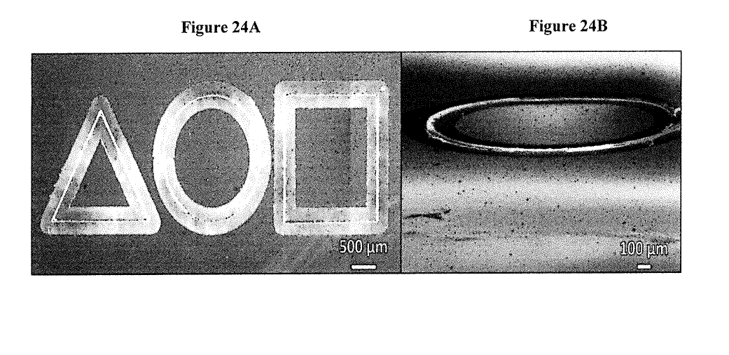

From a 1.6 μm bismuth film, triangle, circle and square shapes as high as 17 μm and as low as 10 μm were realized (FIG. 24). Each side of each triangle, circle and square was constructed from the combined dewetted material originating from 18 adjacent scanner passes (9 from each side) which were pushed together to form the intended geometry. Each pass was spaced at 20 μm. The shapes were formed with clean lines and uniformity of width. An artifact from the geometry of the multiple passes caused a variation in the accumulated height along the length of the shapes parallel to the substrate. The highest areas of accumulation occurred near vertices, as the laser passes needed to create them converged to bring a greater amount of material towards the shape in that area than at the edges of the shape. In contrast, the circle remained consistent in height throughout the length.

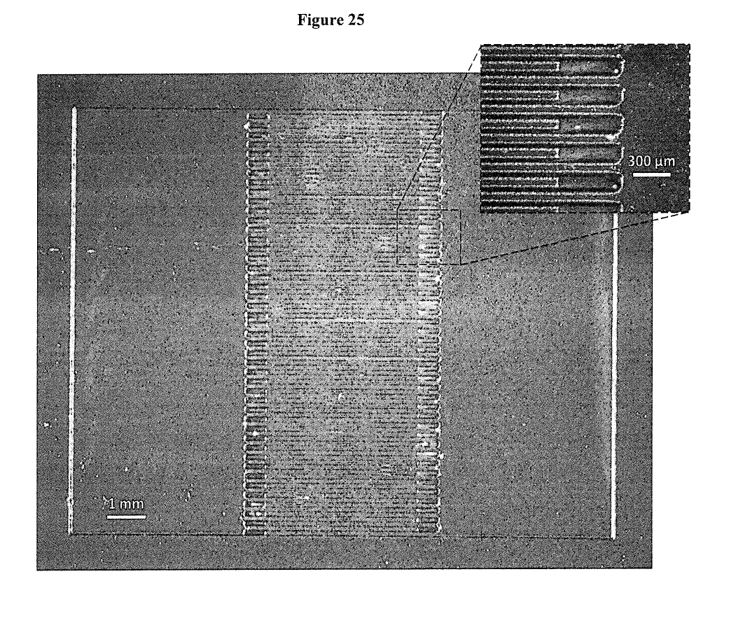

Additionally, an application-oriented design was attempted. Inter-digit electrodes (IDEs) were dewet from a 1.6 μm Bi film using general laser parameters. Such IDEs can be constructed with variable spacing, variable electrode width, variable height, and lends itself well to defocused laser processing to normalize the height of the dewetted beads In total, each electrode was designed with 45 inter-digits each. A large IDE array with a set pitch of 110 μm was dewetted from a 1.6 μm Bi film on a parc-C coated borosilicate slide. The attempted IDEs were designed with an electrode width of 80 um with a spacing of 30 μm. Together, the IDE filled an area 14 mm by 10 mm. The IDE had two electrode pads, each with 45 inter-digits. These inter-digits measured 80 μm wide and had a space of 30 μm in between adjacent inter-digits and were used to explore the completeness of the dewetting process by electrical isolation tests. (FIG. 25). A two point resistance test between the two electrode pads produced resistance values exceeding the Gigaohm capacity of the ohmmeter. Additionally, each electrode pad exhibited electronic isolation from the surrounding as-deposited film. For this example, each inter-digit was constructed with only one pass of the beam, indicating that complete dewetting occurred under the described general laser parameters. Without being bound by theory, alternative design geometries may allow further increase of the spacing in between each inter-digit by introducing additional laser passes between digits, which may also have the effect of increasing the cross-sectional height of the inter-digits via a preferential accumulation “push” mechanism, while defocused exposure of the IDE may create uniformly thick digits that still measure thicker than the original film.

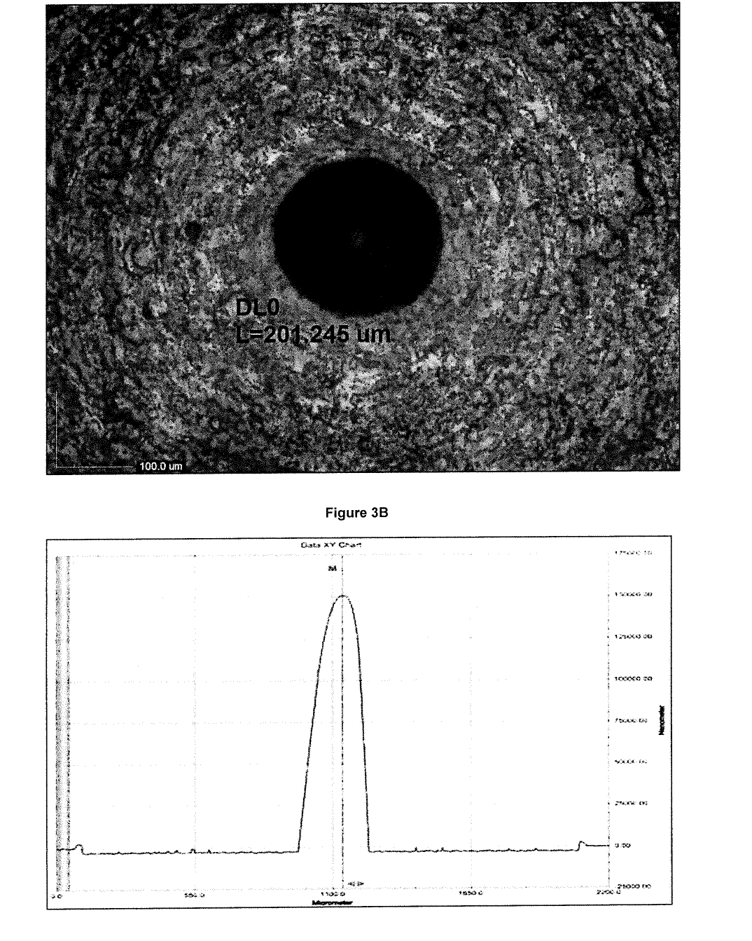

By scanning in a spiral pattern, a cone structure created from dewetted material was realized. Height and width dimensions of this cone/bump structure was determined by the number of layers in the spiral pattern as well as the surface energies of the particular material (FIG. 3). FIG. 3A shows a top down view of such a cone/bump structure with a 100 μm maximum inner radius. Profilometer measurements (FIG. 3B) indicated a maximum height of 150 μm, which is 75 times thicker than the base material (2.0 μm). The laser parameters for this trial were as follows: 50 kHz, 5 μs, 10 W, 350 mm/s, with a cover gas flow of 80 SCFH. The sample consisted of 2.0 μm of Bismuth. The substrate consisted of 16 μm of parylene-C polymer on top of a 1 mm borosilicate glass slide.

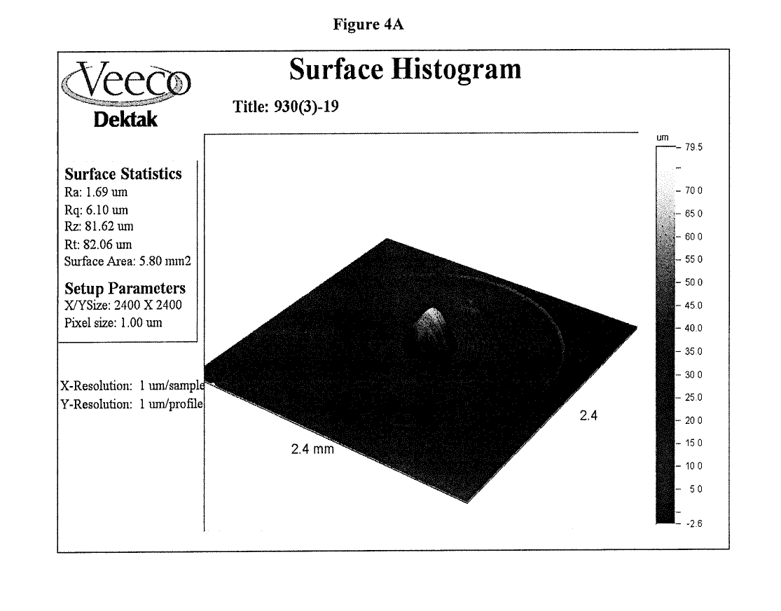

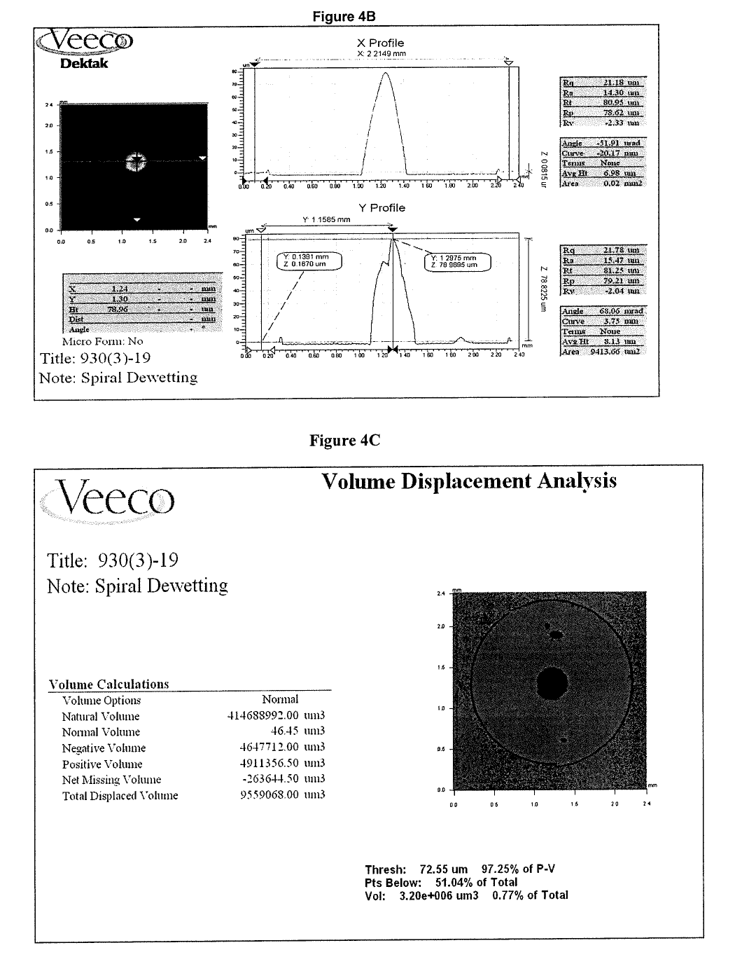

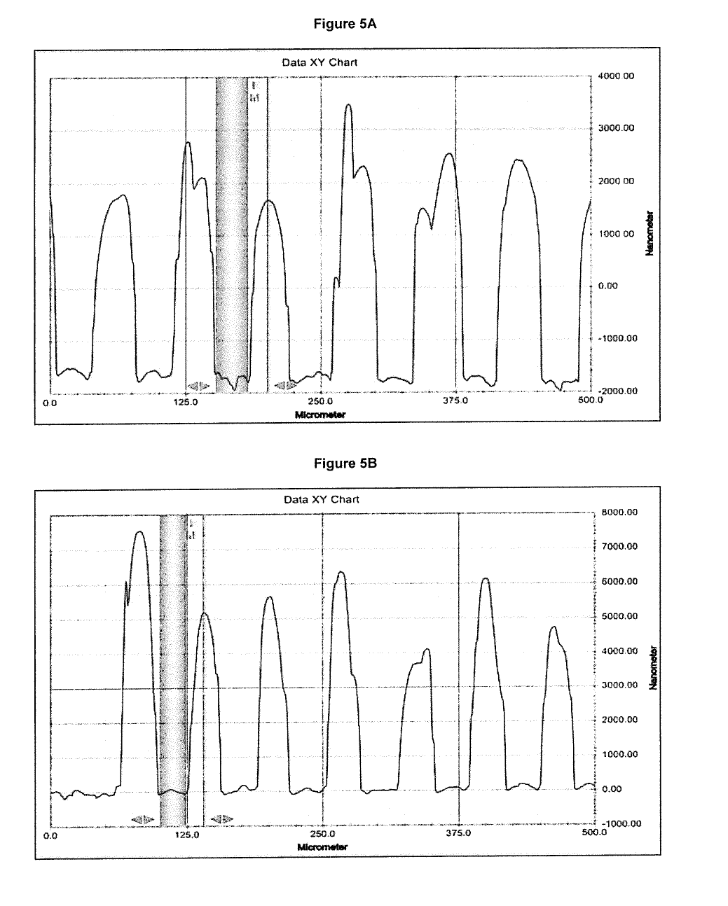

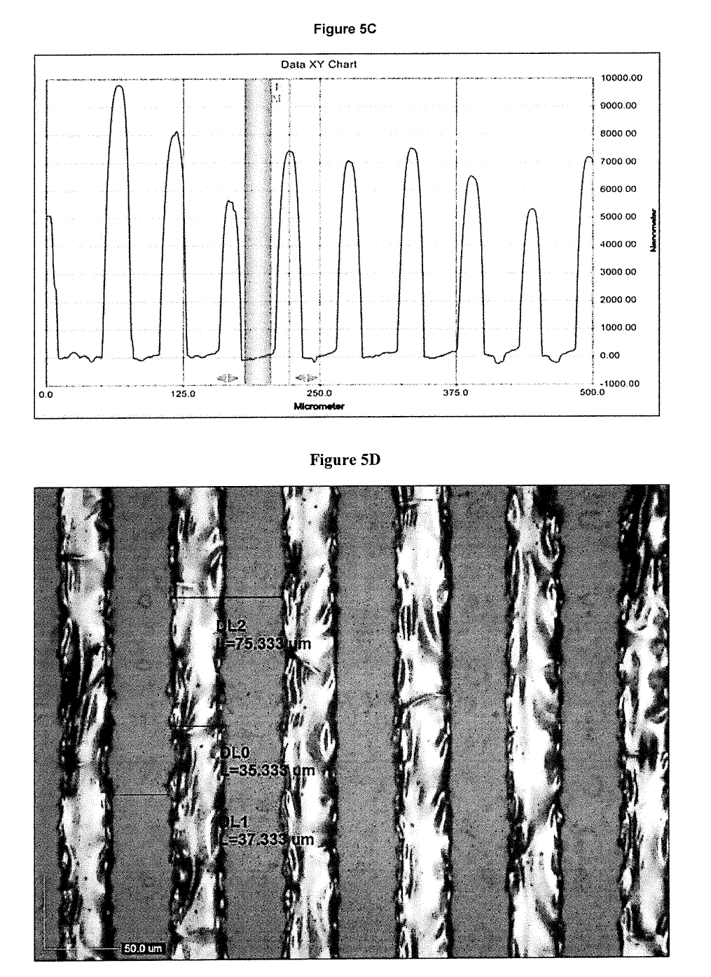

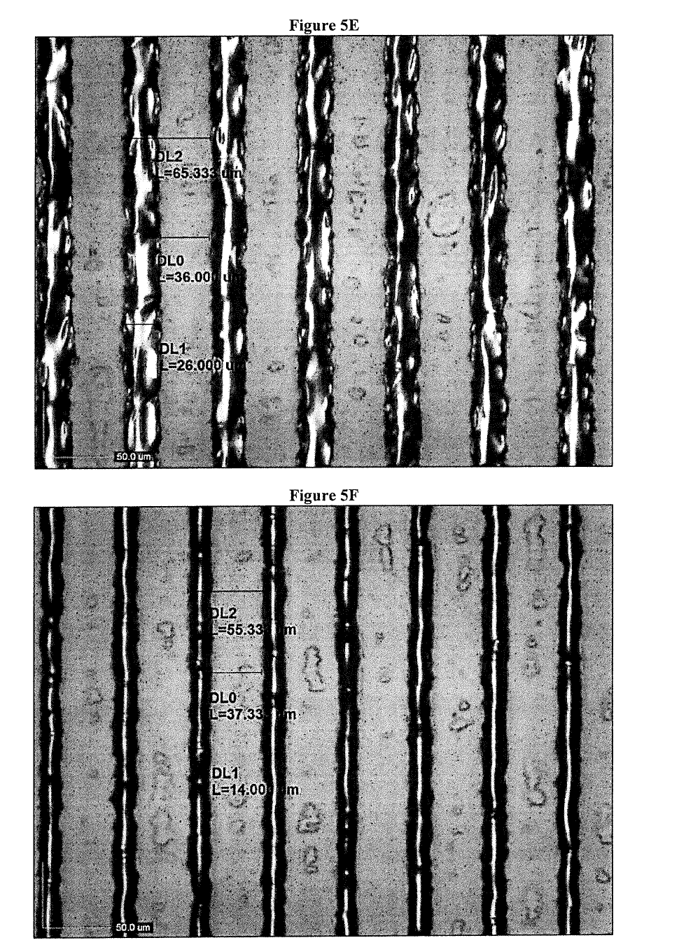

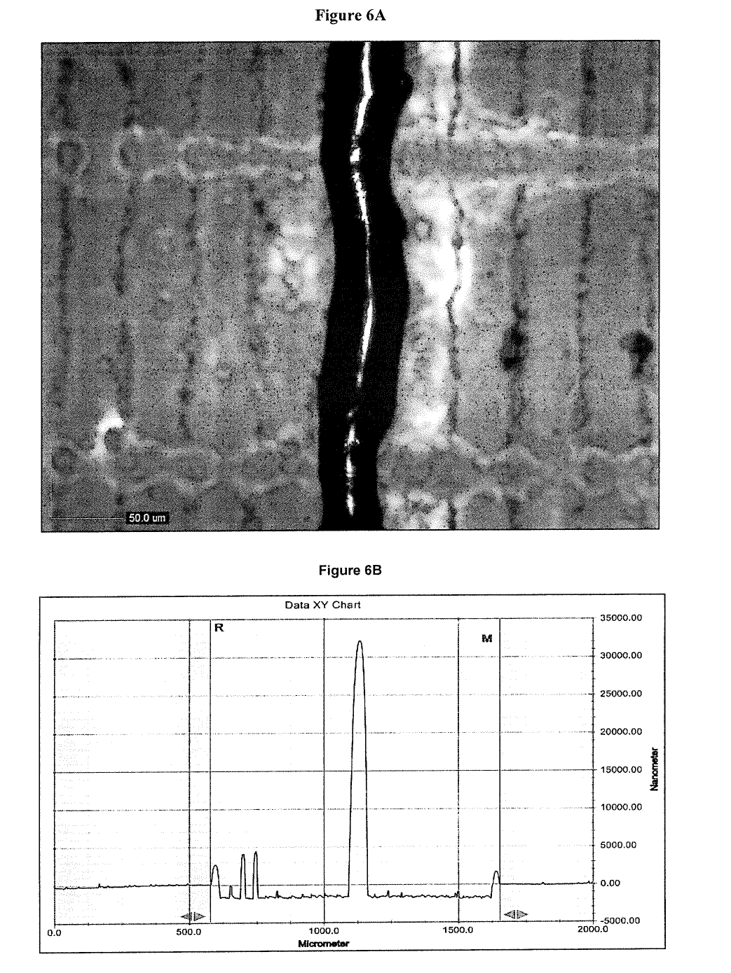

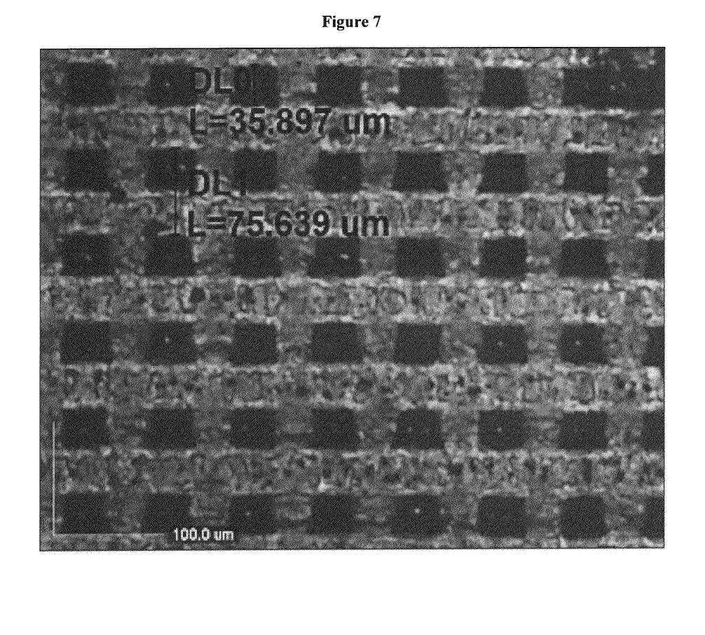

A 3D scan of a second spiral trial (FIG. 4) allowed for volumetric analysis of the cone/bump structure, the result of which indicated that less than 3% of the displaced volume was unaccounted. This is within the margin of error for the measurement, and suggests that there was negligible material ablation. The laser settings were as follows: 50 kHz, 50 μs, 10 W, 350 mm/s, cover gas at 80 SCFH. Each beam pass was centered 50 μm apart from the center of the previous pass. A final maximum inner radius of 150 μm was realized. This sample consisted of 1.5 μm of bismuth on top of 16 μm of parylene-C polymer and a 1 mm thick borosilicate glass slide.

Complex Structures

As an example of the level of complexity possible with the scan system and dewetting technique beyond simple polygonal or circular shapes, the letters “R” and “U” were designed using the described techniques. Both letters were constructed using general laser settings as described in Examples 5 and 6. The attempted “R” was pushed together from 18 beam passes (9 passes on each side) with a 20 μm spacing. The attempted “U” was designed as an IDE with two inter-digits per electrode pad. Each digit is 70 μm wide and spaced 30 μm apart from each other. Each letter created was designed to fit within a 2.3 mm×2.3 mm square.

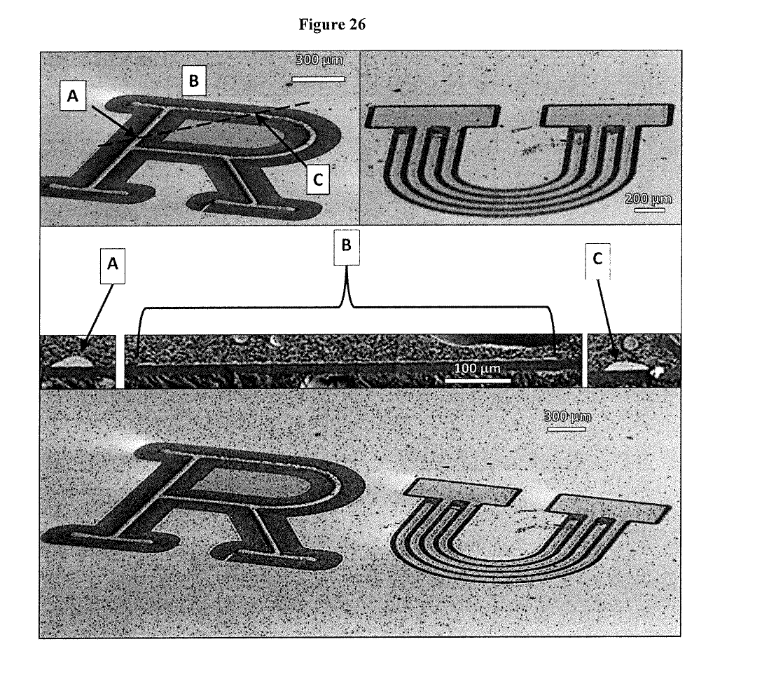

For the first letter (capital “R”) a “push” approach was attempted. To this end, nine successive passes of the laser with a pitch of 20 μm were used to push material from the outside of the “R” to create the general shape of the letter. Nine passes from within the closed section of the “R” pushed material outward to finish the shape of the letter. The second letter chosen was a “U” and was designed as a small IDE. Each electrode pad boasted only two inter-digits, each curved to make the body of the letter. Cross-sectional views of the constructed features were created using conductive epoxy and ion cross-polishing, which highlighted the magnitude of the features in light of the deposited film. Despite the complex shape, electronic isolation was maintained. The resistance values measured across the electrodes exceeded the capacity of the Gigaohm range of the ohmmeter, which indicated that neither the shape of “pushed” structures nor the shape of IDEs had an effect on the completeness of dewetting. Height values for the accumulated “R” structure measured at 10 μm in most locations, but rose to 17 μm in certain areas of the letter, most notably in the serifs of the “R.” The “U” IDE exhibited typical heights for beads created form a single laser pass and measured 3.2 μm from the par-C substrate (FIG. 26).

Notably, after preparing the target and drawing the scanner program, dewetting the bismuth into the “R” feature took 0.66 seconds to complete and the “U” feature took 0.23 seconds to complete.

The lowered absorption of NIR light characteristic of the underlying substrates proves especially advantageous when building up dewetted structures, since this prevents serious substrate damage of the par-C or glass after successive, overlapping passes.

### Example 8

### Physical and Electronic Characterization

Samples were characterized using an optical microscope (Leitz) and a field-emission scanning electron microscope (FESEM) operating at 5 kV. Sample features were encased in a silver-containing, conductive epoxy to limit charging effects during characterization. A diamond band saw running at 250 rpm and an ion cross-polishing system (JEOL) running at 5.5 kV, were used to cut and polish cross-sectional samples of the constructed features. Singular profilometry scans were conducted with a Dektak 150 profilometer with a lateral resolution of 0.050 μm per sample. Three-dimensional models and volumetric data were processed with Veeco “Vision” software.

While the present invention has been described with reference to the specific embodiments thereof it should be understood by those skilled in the art that various changes may be made and equivalents may be substituted without departing from the true spirit and scope of the invention. In addition, many modifications may be made to adopt a particular situation, material, composition of matter, process, process step or steps, to the objective spirit and scope of the present invention. All such modifications are intended to be within the scope of the claims appended hereto.

What is claimed is:

1. A method of patterning a thin film deposited on a substrate comprising:
(A) applying a moving focused field of thermal energy to the thin film deposited on the substrate; and
(B) dewetting the thin film from the substrate,
the dewetting being characterized by:
(i) a negative space of a desired design; and
(ii) displacement of the thin film into adjacent structures, thereby accumulating thin film in the adjacent structures.

2. The method according to claim 1, wherein the focused field of thermal energy is from a laser.

3. The method according to claim 1, wherein the focused field of thermal energy is at a wavelength matched to the wavelength absorbed by the thin film.

4. The method according to claim 3, wherein the wavelength is not absorbed by the substrate.

5. The method according to claim 1, wherein the thin film is an inorganic compound.

6. The method according to claim 1, wherein the thin film is comprised of a metal or metal alloy.

7. The method according to claim 6, wherein the metal is comprised of bismuth.

8. The method according to claim 6, wherein the metal is comprised tin.

9. The method according to claim 1, wherein the substrate is an inorganic substance.

10. The method according to claim 9, wherein the inorganic substance is selected from the group consisting of glass, ceramic, silicon oxide and silicon nitride.

11. The method according to claim 10, wherein the inorganic substance is glass.

12. The method according to claim 11, wherein the glass is borosilicate glass.

13. The method according to claim 1, wherein the substrate is a polymer.

14. The method according to claim 13, wherein the polymer is parylene.

15. The method according to claim 14, wherein the parylene is parylene C.

16. The method according to claim 1, wherein the substrate is a polymer coated on an inorganic substance.

17. The method according to claim 16, wherein the polymer is parylene.

18. The method according to claim 17, wherein the parylene is parylene C.

19. The method according to claim 16, wherein the inorganic substance is selected from the group consisting of glass, ceramic and metal.

20. The method according to claim 19, wherein the inorganic substance is glass.

21. The method according to claim 20, wherein the glass is borosilicate glass.

22. The method according to claim 1, wherein the dewetting is further characterized by minimal ablation of the thin film.

23. The method according to claim 22, wherein the minimal ablation of the thin film is less than 10%.

24. The method according to claim 22, wherein the minimal ablation of the thin film is less than 5%.

25. The method according to claim 22, wherein the minimal ablation of the thin film is less than 3%.

26. The method according to claim 22, wherein the minimal ablation of the thin film is 2.8%.

27. The method according to claim 22, wherein the minimal ablation of the thin film is 0.5%.

28. A patterned film on a substrate obtained by the method according to claim 1.

29. Use of the patterned film according to claim 28 for the fabrication of flexible and non flexible electronics, neural arrays, sensors, electrochromics, electrochemical actuators, artificial muscles, batteries, capacitors, displays, electrochemical actuators, mechanical energy harvesters, micro fluidics, artificial eyes, and antennae.
